(19) United States
(12) Patent Application Publication
(10) Pub. No.: US 2010/0225454 A1
(43) Pub. Date: Sep. 9, 2010

(54) WIRELESS TAG CONTROL METHOD, WIRELESS TAG, AND WIRELESS TAG CONTROL PROGRAM

(75) Inventors: Satoshi INANO, Kawasaki (JP); Shinichi Shiotsu, Kawasaki (JP); Hideki Tanaka, Kawasaki (JP); Daisuke Yamashita, Kawasaki (JP); Isamu Yamada, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/604,810

(22) Filed: Oct. 23, 2009

(30) Foreign Application Priority Data
Mar. 3, 2009 (JP) 2009-049780

(51) Int. Cl. H04Q 5/22

(52) U.S. Cl. 340/10.31

(57) ABSTRACT

A wireless tag operable to communicate with a reader/writer, the wireless tag including a sensor that measures a physical quantity and converts the measured physical quantity into an electrical signal and determines whether a pattern formed by the electrical signal corresponds to a first pattern stored in advance in a storage unit and a communicating unit that starts communication with the reader/writer when the sensor determines that the pattern corresponds to the first pattern.

### CROSS-REFERENCE TO RELATED APPLICATIONS

This application claims the benefit of priority from Japanese Patent Application No. 2009-49780 filed on Mar. 3, 2009, which is herein incorporated by reference in its entirety.

### BACKGROUND

1. Field

Various embodiments described herein relate to a wireless tag control method for controlling a wireless tag that communicates with a reader/writer, the wireless tag, and a wireless tag control program.

2. Description of the Related Art

In recent years, an RFID (Radio Frequency Identification) technique for using a wireless tag to manage logistics or gather information has attracted attention (see, for example, Japanese Patent Application Laid-Open No. 2007-34866).

The wireless tags are classified into an active-type, which includes a built-in battery and in which electric power for activation is internally supplied, and a passive-type, which does not include a built-in battery and which is activated by electric power based on a high frequency transmitted from a reader/writer. If a built-in battery is depleted in the active-type wireless tag, the battery or the wireless tag needs to be replaced.

Therefore, power saving is attempted in a control method described in Japanese Patent Application Laid-Open No. 2007-34866 by starting transmission of a wireless signal when a built-in sensor detects a vibration or illuminance.

### SUMMARY

A wireless tag operable to communicate with a reader/writer includes a sensor that measures a physical quantity and converts the measured physical quantity into an electrical signal and determines whether a pattern formed by the electrical signal corresponds to a first pattern stored in advance in a storage unit and a communication unit that starts communication with the reader/writer when the sensor determines that the pattern formed by the electrical signal corresponds to the first pattern.

A wireless tag control method for controlling a wireless tag that communicates with a reader/writer, the wireless tag control method includes passing the wireless tag through a generating unit that is placed near the reader/writer and that generates a pattern and starting communication between the reader/writer and the wireless when a sensor in the wireless tag detects the pattern and determines that the detected pattern matches a pattern previously stored in a storage unit of the wireless tag.

### BRIEF DESCRIPTION OF THE DRAWINGS

FIG. 1 is a schematic diagram of an overview of a control system;

FIG. 2 is an explanatory view of an example of another generating unit;

FIG. 3 is a block diagram of a reader/writer and hardware of a computer;

FIG. 4 is a block diagram of hardware of a wireless tag;

FIG. 5 is a time chart of transmission and reception states of signals between the reader/writer and the wireless tag;

FIG. 6 is a flow chart of a procedure of transmission and reception;

FIG. 7 is a flow chart of a procedure of transmission and reception;

FIG. 8 is a schematic diagram of an overview of a control system according to a second embodiment;

FIG. 9 is an explanatory view of an example of another generating unit and a second generating unit;

FIG. 10 is a flow chart of a procedure of transmission and reception according to the second embodiment;

FIG. 11 is a flow chart of a procedure of transmission and reception according to the second embodiment;

FIG. 12 is a flow chart of a procedure of a transmission and reception process;

FIG. 13 is a flow chart of a procedure of a transmission and reception process;

FIG. 14 is a flow chart of a procedure of a transmission and reception process;

FIG. 15 is a schematic diagram of an overview of a control system according to a third embodiment;

FIG. 16 is a schematic diagram of an overview of a control system according to a fourth embodiment;

FIG. 17 is a block diagram of hardware of a wireless tag according to the fourth embodiment;

FIG. 18 is a time chart of a transition of light emission or non-light emission of an LED;

FIG. 19 is a flow chart of a procedure using a pattern and an auxiliary pattern;

FIG. 20 is a flow chart of a procedure using a pattern and an auxiliary pattern;

FIG. 21 is a flow chart of a procedure using a pattern and an auxiliary pattern;

FIG. 22 is a schematic diagram of an overview of a control system according to a fifth embodiment;

FIG. 23 is a flow chart of a procedure using a pattern, an auxiliary pattern, and a second pattern;

FIG. 24 is a flow chart of a procedure using a pattern, an auxiliary pattern, and a second pattern;

FIG. 25 is a flow chart of a procedure using a pattern, an auxiliary pattern, and a second pattern;

FIG. 26 is a flow chart of a procedure using a pattern, an auxiliary pattern, and a second pattern;

FIG. 27A is an explanatory view of record layouts of a pattern storage unit and an auxiliary pattern storage unit;

FIG. 27B is an explanatory view of record layouts of an auxiliary pattern storage unit;

FIG. 28 is an explanatory view of an image of a pattern selection screen;

FIG. 29 is a flow chart of a procedure of pattern registration;

FIG. 30 is a flow chart of a procedure of pattern registration;

FIG. 31 is a flow chart of a procedure of pattern registration;

FIG. 32 is a block diagram of hardware of a wireless tag according to a seventh embodiment;

FIG. 33 is a flow chart of a procedure of a transmission and reception process; and

FIG. 34 is a flow chart of a procedure of a transmission and reception process.

### DETAILED DESCRIPTION OF THE EMBODIMENTS

A problem remains in the conventional control method that the sensor may erroneously detect a vibration or illuminance, and the power saving cannot be attained sufficiently.

Another problem remains that a collision between a response signal transmitted by a wireless tag and a response signal of another wireless tag occurs if the wireless tag malfunctions.

In a wireless tag control method disclosed below, a wireless tag passes through a generating unit that generates a pattern, and communication starts on the condition that a sensor detects the pattern. As a result, accurate communication with a reader/writer can be performed, and power saving can be realized.

According to one aspect of the control method, the generating unit arranged near the reader/writer generates the pattern, and the communication starts only when the sensor detects the pattern. Therefore, a collision caused by a wireless tag that has not passed through the generating unit can be prevented, and accurate communication can be realized.

As a result, excellent effects can be achieved, such as reducing the start of unnecessary communication, and attaining the power saving.

### First Embodiment

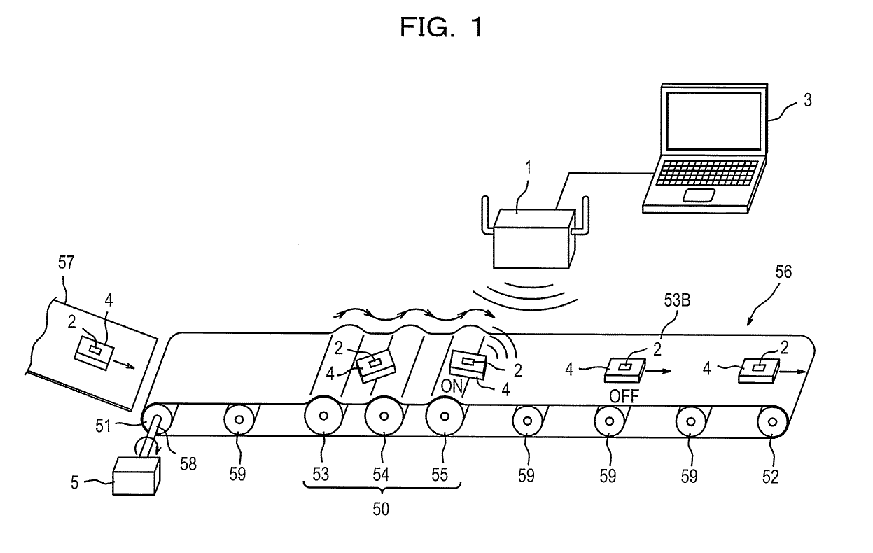

FIG. 1 illustrate a schematic diagram of an overview of a control system. The control system includes a reader/writer 1, a computer 3, wireless tags 2, 2, 2, . . . , a conveyor belt 56, a generating unit 50, rollers 51 and 52, a belt 53B, a slider 57, a driving unit 5, etc. The wireless tag 2 is attached to a management object 4, such as a commodity, a container, a suitcase, mail, clothes, an animal, and a human body, by pasting or embedding. An example that the management object 4 is a commodity 4 and that the wireless tag 2 is pasted on the upper surface of the commodity 4 will be described below.

The reader/writer 1 is connected to the computer 3 in a wired or wireless manner and transmits and receives signals to and from the wireless tags 2, 2, 2, . . . according to an instruction of the computer 3.

In the present embodiment, an example that the reader/writer 1 forms a wired connection with the computer 3 will be described. However, the computer 3 including a built-in reader/writer 1 may transmit and receive signals to and from the wireless tag 2. Although an example that one reader/writer 1 is connected to the computer 3 will be described, the computer 3 may control a plurality of reader/writers 1, 1, 1, . . . .

The wireless tag 2 is an active-type including a built-in battery (hereinafter, “power source unit”), and the power source unit supplies electric power for a given time when a sensor detects a given pattern. The wireless tag 2 starts communication with the reader/writer 1 when the electric power is supplied. The power supply from the power source unit terminates after a certain time (for example, after several seconds), and the communication with the reader/writer 1 ends.

In the present embodiment, an example that the conveyor belt 56 is used as the generating unit 50 that generates a pattern for the wireless tag 2 will be described. The driving unit 5 of the conveyor belt 56 comprises a motor (not shown) and is linked to a roller 51 arranged at one end through a rotating shaft 58 of the motor. When the driving unit 5 rotates the rotating shaft 58, the roller 51 also rotates accordingly, and then the belt 53B, in which the roller 51 and the roller 52 at the other end hold both ends of the internal surface, rotates. The driving unit 5 rotates the rotating shaft 58 clockwise. The commodity 4 supplied from the slider 57 is transferred from left to right over the belt 53B as viewed from the front.

The reader/writer 1 that reads and writes information to and from the wireless tag 2 is placed at the approximate center of the conveyor belt 56. The generating unit 50 that generates a pattern is arranged near the reader/writer 1.

In the description of the present embodiment, three cylindrical generation rollers 53, 54, and 55 (hereinafter, represented by a generation roller 50 in some cases) in the generating unit 50 are inserted into the internal surface of the resin belt 53B at given intervals, the generation rollers 53, 54, and 55 having diameters greater than the diameters of the rollers 51 and 52 at both ends. The given intervals can be appropriate intervals in accordance with the size of the commodity 4, and for example, the intervals between the generation rollers 53, 54, and 55 can be 5 cm. The generation rollers 53, 54, and 55 do not have to be equally spaced apart, and the interval between the first generating roller 53 and the second generation roller 54 and the interval between the second generating roller 54 and the third generation roller 55 may be different.

The diameters of the generation rollers 53, 54, and 55 are greater than the diameters of the rollers 51 and 52 at both ends and the rollers 59, 59, and 59 arranged in the middle. Therefore, the belt 53B forms a waveform in which three ridges appear at given intervals on the generation rollers 53, 54, and 55 as viewed from the side. If an internal sensor detects the vertical movement for three consecutive times as a pattern within a given time, the wireless tag 2 turns on and starts communication with the reader/writer 1. The given time is, for example, two seconds, and the given time can be set to an appropriate value according to the movement speed of the belt 53B. The wireless tag 2 turns off after a certain time.

The generating unit 50 only needs to be arranged near the reader/writer 1, and for example, the generating unit 50 can be arranged in a range in which the wireless tag 2 of the reader/writer 1 can be detected. Alternatively, the generating unit 50 can be located in a range in which the rear end (the generation roller 55 in the present example) of the generating unit 50 can detect the wireless tag 2 of the reader/writer 1. The turned off wireless tag 2 is transferred over the belt 53B toward the roller 52 at the other end and is ultimately retrieved. Although three generation rollers 53, 54, and 55 are used as the generating unit 50 in the example of the present embodiment, the arrangement is not limited to this. For example, two or more generation rollers 50 need to be used, and the number is not limited.

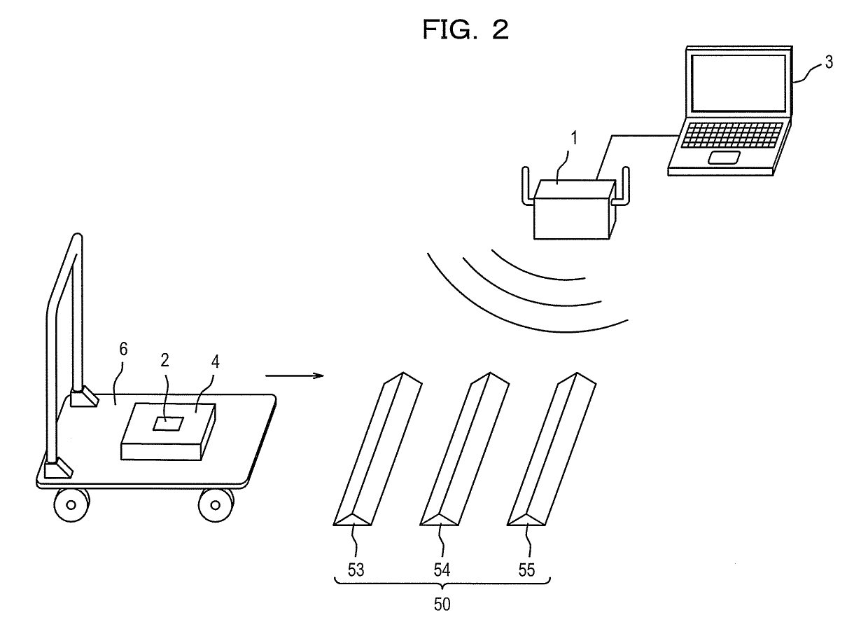

FIG. 2 is an explanatory view of an example of the generating unit 50. The commodity 4 attached with the wireless tag 2 on the upper surface is placed on a carriage 6. The user moves the carriage 6 in a direction illustrated with an arrow where the reader/writer 1 exists. Three triangular prisms 53, 54, and 55 are pasted as the generating unit 50 near the reader/writer 1. The three triangular prisms 53, 54, and 55 are made of, for example, resin or metal and are placed at given intervals, in which a direction crossing the traveling direction of the carriage 6 is the longitudinal direction. In addition to the triangular prisms 53, 54, and 55 described in the present embodiment, a plurality of semicircular prisms or quadrangular prisms are spaced apart and placed in the traveling direction of the carriage 6 to generate a pattern in which the vertical movement continues for three times within a given time.

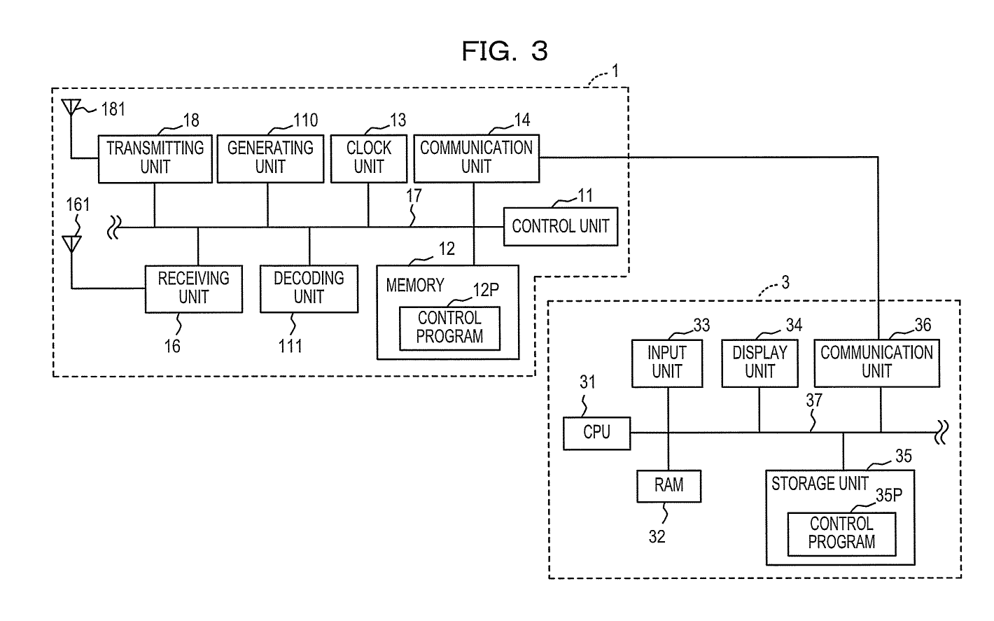

FIG. 3 is a block diagram of hardware of the reader/writer 1 and the computer 3. Examples of the computer 3 include: a personal computer; a PDA (Personal Digital Assistance); a control apparatus used in an airport, a cargo center, a factory, etc.; and a server computer. The computer 3 is a personal computer in the following description.

The computer 3 includes a CPU (Central Processing Unit) 31, a RAM (Random Access Memory) 32, a storage unit 35, a communication unit 36, an input unit 33, a display unit 34, etc. The CPU 31 is connected to and controls the hardware components through a bus 37 and performs various software functions according to a control program 35P stored in the storage unit 35. Examples of the input unit 33 include a keyboard and a mouse, and the input unit 33 inputs control information, etc., for the reader/writer 1. Examples of the display unit 34 include a liquid crystal display and an organic EL (Electro-Luminescence) display, and the display unit 34 displays information related to the reader/writer 1 and the wireless tag 2. An example of the storage unit 35 includes a hard disk, and the storage unit 35 stores the control program 35P for controlling the reader/writer 1, an OS (Operating System), and various other data. An example of the communication unit 36 is a USB (Universal Serial Bus) port, and the communication unit 36 transmits and receives information to and from the communication unit 14 of the reader/writer 1.

The reader/writer 1 includes a control unit 11, a memory 12, a clock unit 13, a communication unit 14, a receiving unit 16, a transmitting unit 18, a generating unit 110, decoding unit 111, a transmission antenna 181, a reception antenna 161, etc. The control unit 11 is connected to and controls the hardware components through a bus 17 and performs various software functions according to a control program 12P stored in the memory 12. An example of the communication unit 14 includes a USB port, and the communication unit 14 transmits and receives information to and from the computer 3. The clock unit 13 outputs time information to the control unit 11. The clock unit 13 does not have to be arranged inside the reader/writer 1, and time information outputted from a clock unit (not shown) inside the computer 3 may be used.

The generating unit 110 encodes control information outputted from the control unit 11 according to a given encoding method. The generating unit 110 outputs the encoded control information to the transmitting unit 18. The transmitting unit 18 modulates the encoded control information and transmits a control signal (RF signal) after modulation to the wireless tag 2 through the transmission antenna 181. A receiving unit 16 receives a response signal transmitted from the wireless tag 2 through the reception antenna 161. The receiving unit 16 demodulates the response signal and outputs response information after demodulation to the decoding unit 111. The decoding unit 111 decodes the response information based on the encoding method and outputs the decoded response information to the control unit 11. The transmission antenna 181 and the reception antenna 161 may be integrated.

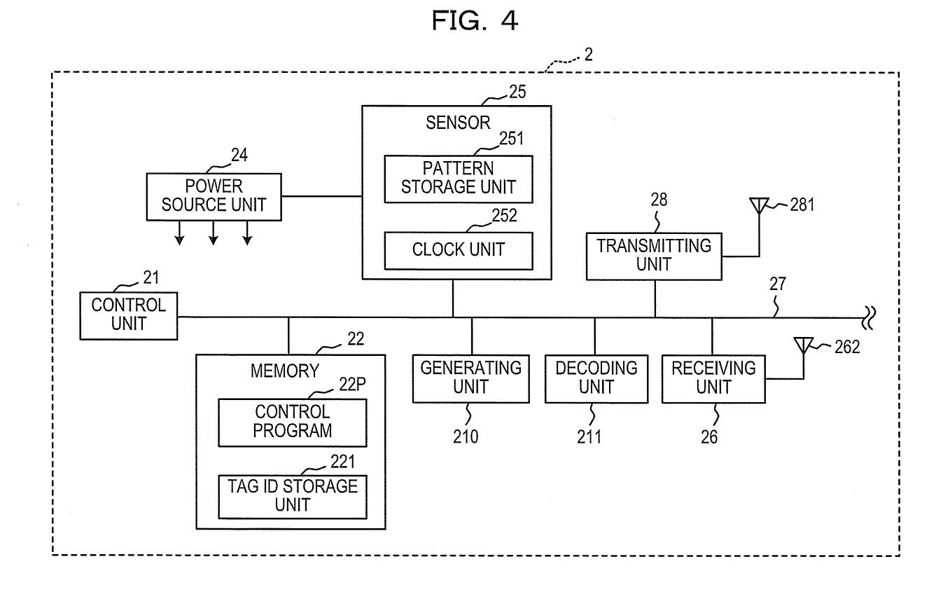

FIG. 4 is a block diagram of hardware of the wireless tag 2. The wireless tag 2 includes a control unit 21 as a communication control unit, a memory 22, a power source unit 24, a sensor 25, a receiving unit 26 and a transmitting unit 28 as wireless communication units, a generating unit 210, a decoding unit 211, a reception antenna 262, a transmission antenna 281, etc. The control unit 21 is connected to and controls the hardware components through the bus 27 and performs various software functions according to a control program 22P stored in the memory 22. The power source unit 24 includes a built-in button battery, etc., and supplies electric power to the hardware. The power source unit 24 continuously supplies electric power to the sensor 25.

Meanwhile, the power source unit 24 supplies electric power to the rest of the hardware including the control unit 21, the memory 22, the generating unit 210, the decoding unit 211, the receiving unit 26, and the transmitting unit 28 when the sensor 25 detects a pattern and outputs an activation signal to the power source unit 24. The receiving unit 26 detects a control signal transmitted from the reader/writer 1 through the reception antenna 262 (carrier sensing). The receiving unit 26 demodulates the detected control signal and outputs control information after demodulation to the decoding unit 211. The decoding unit 211 decodes the control information according to the encoding method and outputs the decoded control information to the control unit 21. The control unit 21 reads a unique tag ID that is stored in a tag ID storage unit 221 of the memory 22 and that is for identifying the wireless tag 2. The control unit 21 outputs response information including the tag ID to the generating unit 210.

The generating unit 210 encodes the response information according to the encoding method. The generating unit 210 outputs the encoded response information to the transmitting unit 28. The transmitting unit 28 modulates the response information and transmits a response signal after modulation to the reader/writer 1 through the transmission antenna 281.

The sensor 25 includes a device that measures a physical quantity and converts it into an electrical signal. Examples of the sensor 25 include an acceleration sensor, a vibration sensor, and an impact sensor. The sensor 25 includes a pattern storage unit 251 and a clock unit 252. The pattern storage unit 251 stores a pattern serving as a trigger for the wireless tag 2 to start communication.

In the example of FIG. 1, the pattern storage unit 251 stores a pattern in which an electrical signal indicating a vertical movement is repeated for three times within a given time. When a pattern formed by the electrical signal is detected, the sensor 25 outputs an activation signal to the power source unit 24 on the condition that the detected pattern and the pattern stored in the pattern storage unit 251 match. After receiving the activation signal, the power source unit 24 supplies electric power to hardware such as the control unit 21. This leads the wireless tag 2 to start communication with the reader/writer 1.

The receiving unit 26 receives a control signal outputted from the transmitting unit 18 of the reader/writer 1 through the reception antenna 262. The control unit 21 receives control information after demodulation and decoding. Triggered by the reception of the control information, the control unit 21 outputs response information including the tag ID stored in the tag ID storage unit 221 to the generating unit 210. The transmitting unit 28 outputs a response signal after encoding and modulation to the reader/writer 1 through the transmission antenna 281.

The sensor 25 refers to time information outputted from the clock unit 252 and transmits a termination signal to the power source unit 24 when determining that a certain time has passed after the output of the activation signal. When receiving the termination signal, the power source unit 24 terminates supplying power to other hardware including the control unit 21, the memory 22, the generating unit 210, the decoding unit 211, the receiving unit 26, and the transmitting unit 28. This ends the communication with the reader/writer 1. Specifically, the receiving unit 26 terminates the detection of a control signal, and the transmitting unit 28 terminates the transmission of a response signal.

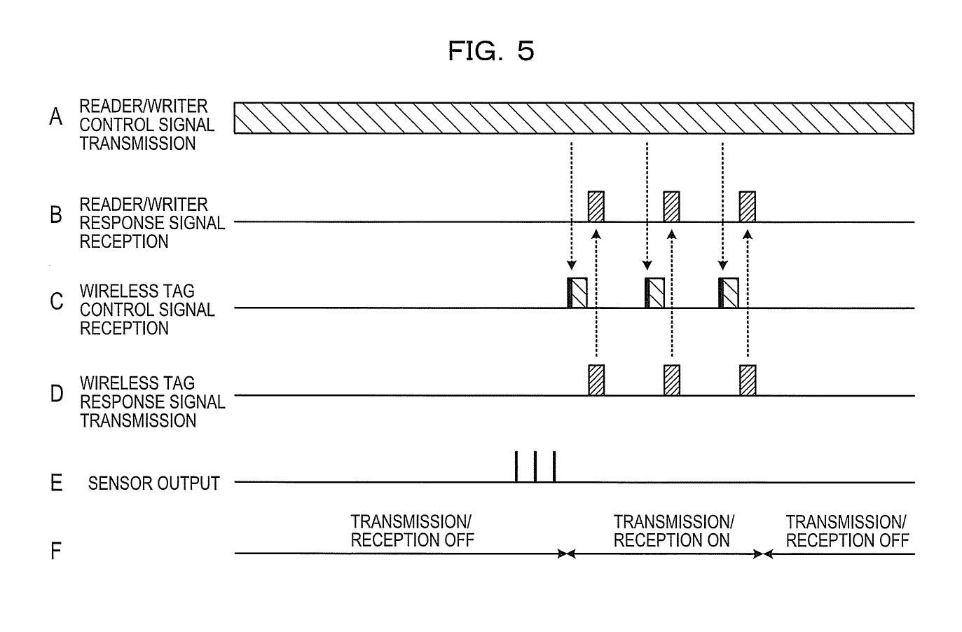

FIG. 5 is a time chart of transmission and reception states of signals between the reader/writer 1 and the wireless tag 2. The horizontal axis of FIG. 5 denotes time, and the vertical axis denotes strength for identifying whether a signal is high or low.

FIG. 5A is a time chart of a change in a control signal transmitted from the transmitting unit 18 of the reader/writer 1. The control unit 11 of the reader/writer 1 continuously transmits the control signal through the transmitting unit 18.

FIG. 5B is a time chart of a change in the reception state in the receiving unit 16 of the reader/writer 1. The receiving unit 16 of the reader/writer 1 can receive a response signal any time from the wireless tag 2 when the reader/writer 1 is ON.

FIG. 5C is a time chart of a reception state of a signal in the wireless tag 2. FIG. 5D is a time chart of a transmission state of a signal in the wireless tag 2. FIG. 5E is a time chart of a change in the output of the sensor 25, and FIG. 5F is a time chart of a change in the ON/OFF state of the transmitting unit 28 and the receiving unit 26. The sensor 25 outputs an activation signal to the power source unit 24 when a pattern (see FIG. 5E) matching the pattern stored in the pattern storage unit 251 is detected.

As shown in FIG. 5F, the turned off transmitting unit 28 and the receiving unit 26 are turned on. As shown with black rectangles, the control unit 21 supplied with the electric power causes the transmitting unit 28 to detect a control signal transmitted from the transmitting unit 18 of the reader/writer 1 at a given period (carrier sensing). The control signal is illustrated with a rectangle with a hatch in the lower right direction. When receiving the control signal through the receiving unit 26, the wireless tag 2 reads a tag ID from the tag ID storage unit 221. The tag ID is unique identification information provided to identify the wireless tag 2. The control unit 21 transmits response signals including the read tag ID to the reader/writer 1 through the transmitting unit 28.

As can be seen in FIGS. 5B and 5D, the wireless tag 2 has transmitted response signals to the reader/writer 1, the response signals indicated with rectangles with hatching in the lower left direction. The sensor 25 monitors the output of the clock unit 252 and outputs a termination signal to the power source unit 24 after detecting that a given time has passed based on the output of the clock unit 252. The power source unit 24 terminates supplying power to the control unit 21.

As shown in FIG. 5F, the turned on transmitting unit 28 and the receiving unit 26 are turned off. As shown in FIGS. 5B to 5D, the carrier sensing is not performed after the transmission of the third response signal, and the wireless tag 2 is again terminated.

In the example described in the present embodiment, the power source unit 24 terminates the wireless tag 2 when the sensor 25 outputs a termination signal. However, the arrangement is not limited to this. For example, after supplying power, the control unit 21 may refer to the output of the clock unit 252 to terminate the transmission of the response signal from the transmitting unit 28 after a certain time (for example, ten seconds) or to terminate the carrier sensing by the receiving unit 26.

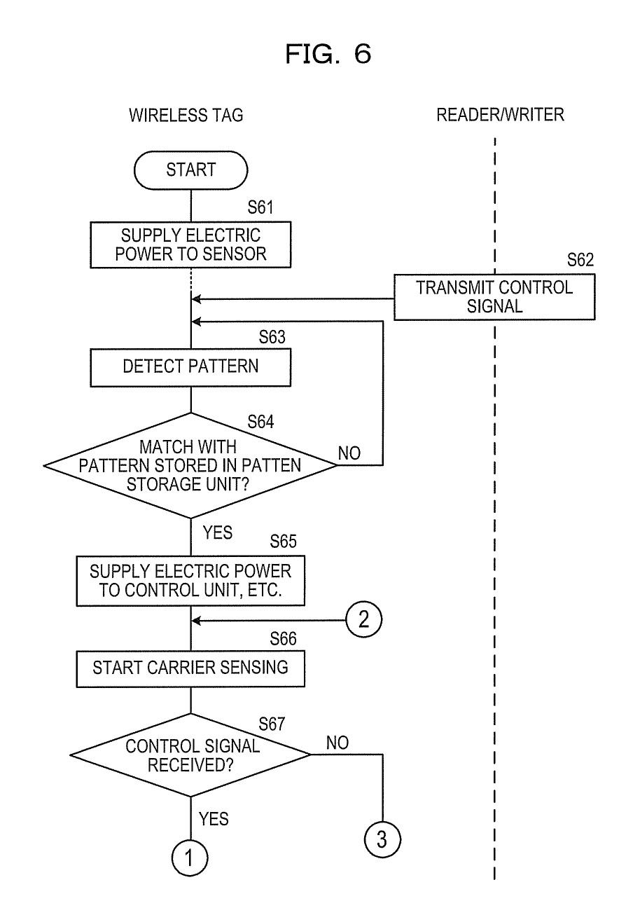

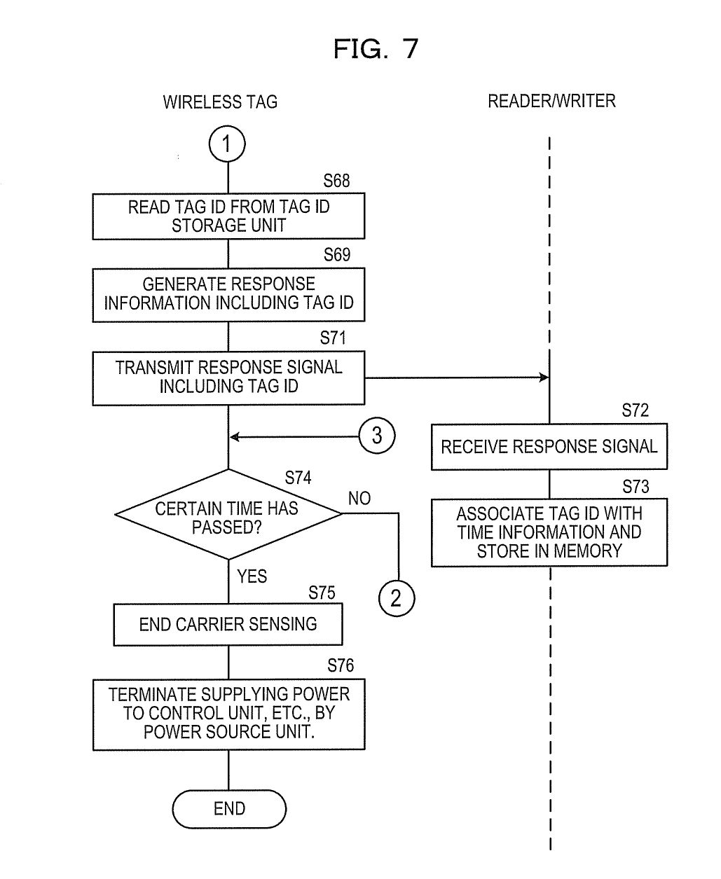

A procedure of transmission and reception in the hardware will be described using a flow chart. FIGS. 6 and 7 illustrate a flow chart of a procedure of transmission and reception.

The power source unit 24 supplies electric power to the sensor 25 of the wireless tag 2 transferred by the conveyor belt 56 (step S61). The power of the reader/writer 1 is turned on when an activation signal from the computer 3 is received. The control unit 11 of the reader/writer 1 then generates control information by the generating unit 110 and outputs the generated control information to the transmitting unit 18. The transmitting unit 18 continuously transmits a control signal after modulation through the transmission antenna 181 (step S62).

Meanwhile, the sensor 25 embedded in the wireless tag 2 performs pattern detection (step S63). The sensor 25 of the wireless tag 2 determines whether the detected pattern matches the pattern stored in the pattern storage unit 251 (step S64). If the sensor 25 determines that the patterns do not match (NO in step S64), the process returns to step S63, and the process is repeated.

On the other hand, the sensor 25 outputs an activation signal to the power source unit 24 if the sensor 25 determines that the patterns match (YES in step S64). Triggered by the reception of the activation signal, the power source unit 24 starts to supply electric power to the control unit 21, the memory 22, the generating unit 210, the decoding unit 211, the receiving unit 26, and the transmitting unit 28 (step S65). The control unit 21 starts carrier sensing by the receiving unit 26 to start communication with the reader/writer 1 (step S66). The receiving unit 26 determines whether a control signal is received (step S67). The receiving unit 26 reads a tag ID from the tag ID storage unit 221 (step S68) if the receiving unit 26 determines that the control signal is received (YES in step S67). The control unit 21 causes the generating unit 210 to generate response information including the tag ID (step S69). The control unit 21 outputs the generated response information including the tag ID to the transmitting unit 28. The transmitting unit 28 modulates the response information and transmits a response signal after modulation to the reader/writer 1 (step S71).

The wireless tag 2 and the reader/writer 1 demodulate and decode the received signals and encode and modulate the signals to be transmitted. However, the description of the processes will be appropriately omitted to simplify the description. The receiving unit 16 of the reader/writer 1 receives a response signal (step S72). The receiving unit 16 outputs response information after demodulation to the control unit 11.

The control unit 11 associates the tag ID in the response information with time information outputted from the clock unit 13 and stores the tag ID and the time information in the memory 12 (step S73). The reader/writer 1 outputs the stored tag ID and the time information to the computer 3 upon every reception or every certain time (for example, every hour). The CPU 31 of the computer 3 receives the tag ID and the time information outputted through the communication unit 36. The CPU 31 stores the tag ID and the time information in the storage unit 35.

After step S71 and when the control unit 21 determines in step S67 that the control signal is not received (NO in step S67), the process moves to step S74. The control unit 21 of the wireless tag 2 refers to the output of the clock unit 252 and determines whether a certain time has passed after the electric power is supplied in step S65 or after the start of the carrier sensing in step S66 (step S74). If the control unit 21 determines that the certain time has not passed (NO in step S74), the process moves to step S66, and the process is repeated. If the control unit 21 determines that the certain time has passed (YES in step S74), the control unit 21 outputs a termination signal of carrier sensing to the transmitting unit 28.

After receiving the termination signal, the transmitting unit 28 ends the carrier sensing (step S75). The control unit 21 outputs a termination signal to the power source unit 24. After receiving the termination signal, the power source unit 24 terminates supplying power to the control unit 21, the memory 22, the generating unit 210, the decoding unit 211, the receiving unit 26, and the transmitting unit 28 (step S76). The sensor 25 may refer to the output of the clock unit 252 and output the termination signal to the power source unit 24 after a certain time.

In this way, a collision with another wireless tag 2 can be prevented since the wireless tag 2 is not activated when the sensor 25 detects a mere impact, etc. Furthermore, the power saving can be attained since the wireless tag 2 is activated only when the generating unit 50 near the reader/writer 1 detects the pattern.

### Second Embodiment

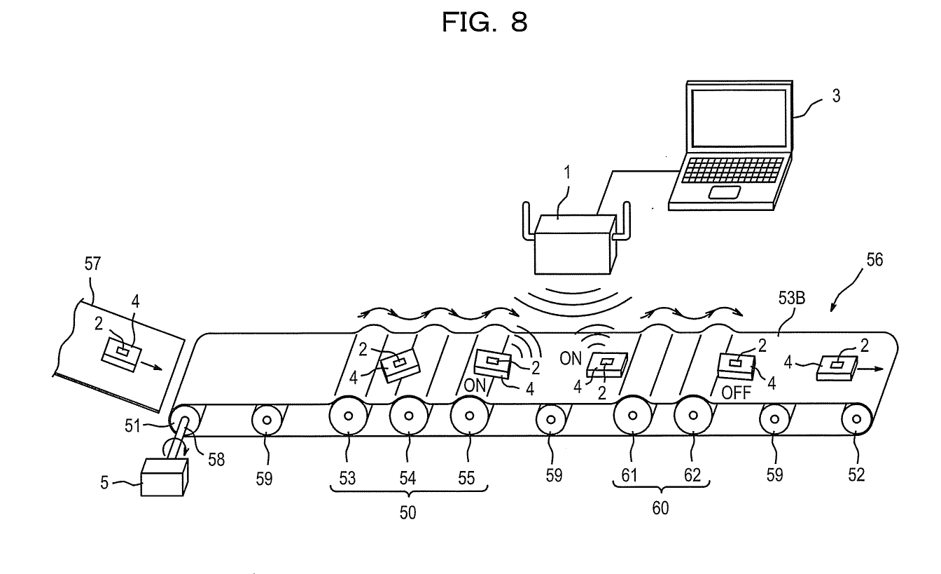

A second embodiment relates to a configuration in which the wireless tag 2 further passes through a second generating unit. FIG. 8 is a schematic diagram of an overview of a control system according to the second embodiment.

A second generating unit 60 is installed and added to the first embodiment 1. The second generating unit 60 is arranged at a certain distance from the generating unit 50 in the downstream in the transfer direction of the wireless tag 2 and near the reader/writer 1. Another reader/writer 1 controlled by the computer 3 may be further installed, and the second generating unit 60 may be arranged near the further installed reader/writer 1. In that case, the second generating unit 60 only needs to belong in the transmission range of the control signal of the reader/writer 1.

Like the generation rollers 53, 54, and 55, two generation rollers 61 and 62 with larger diameters than the roller 59, etc., are used in the second generating unit 60. The second generating unit 60 generates a pattern for the wireless tag 2, the pattern different from the pattern generated by the generating unit 50. The generation rollers 61 and 62 are inserted to the internal surface of the belt 53B with a given interval. The diameters of the generation rollers 61 and 62 are greater than the diameters of other rollers, such as the roller 59. Therefore, the belt 53B expands in an arc around the upper part of the generation roller 61. The belt 53B between the generation rollers 61 and 62 again becomes parallel to the floor. The belt 53B again expands in an arc around the upper part of the generation roller 62 in the downstream.

In the present example, the generating unit 50 generates a pattern in which the vertical movement continues for three times at certain time intervals, and the second generating unit 60 generates a second pattern in which the vertical movement continues twice at a certain time interval. The generating unit 50 and the second generating unit 60 may be configured in other ways as long as the generated pattern and second pattern are different. For example, the generation unit 50 may include two generation rollers, and the second generation unit 60 in the subsequent stage may include three generation rollers.

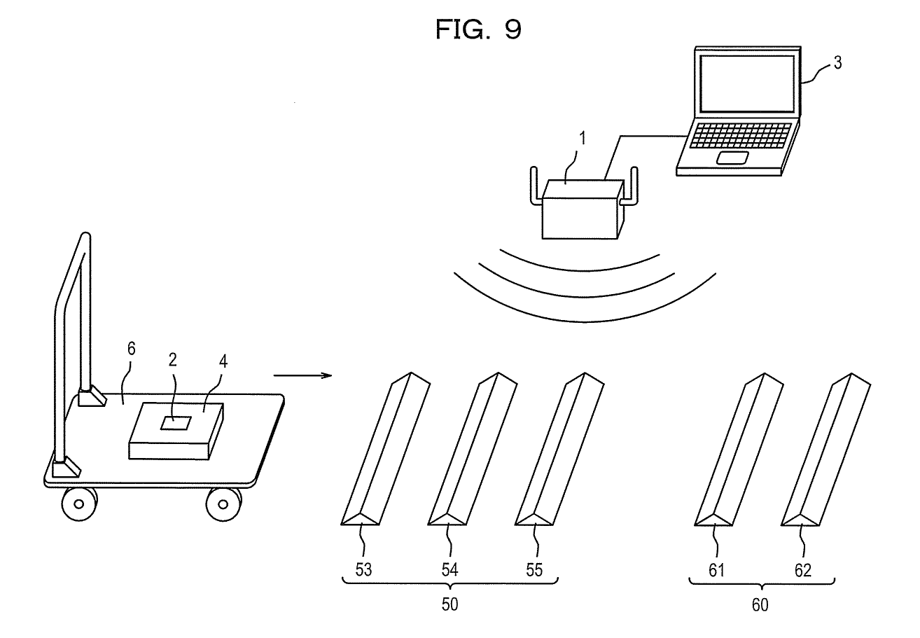

FIG. 9 is an explanatory view of another example of the generating unit 50 and the second generating unit 60. In addition to the generating unit 50 shown in FIG. 2, the second generating unit 60 is further placed in the downstream in the transfer direction of the carriage 6. Two triangular prisms 61 and 62 are attached to the floor surface with a given interval in the second generating unit 60. The generating unit 50 and the second generating unit 60 are separated by a certain distance (for example, 2 m).

In this way, the wireless tag 2 on the carriage 6 detects the pattern in which the vertical movement by the generating unit 50 continues for three times at certain time intervals. The wireless tag 2 on the carriage 6 then detects the second pattern in which the vertical movement by the second generating unit 60 continues twice at a certain time interval.

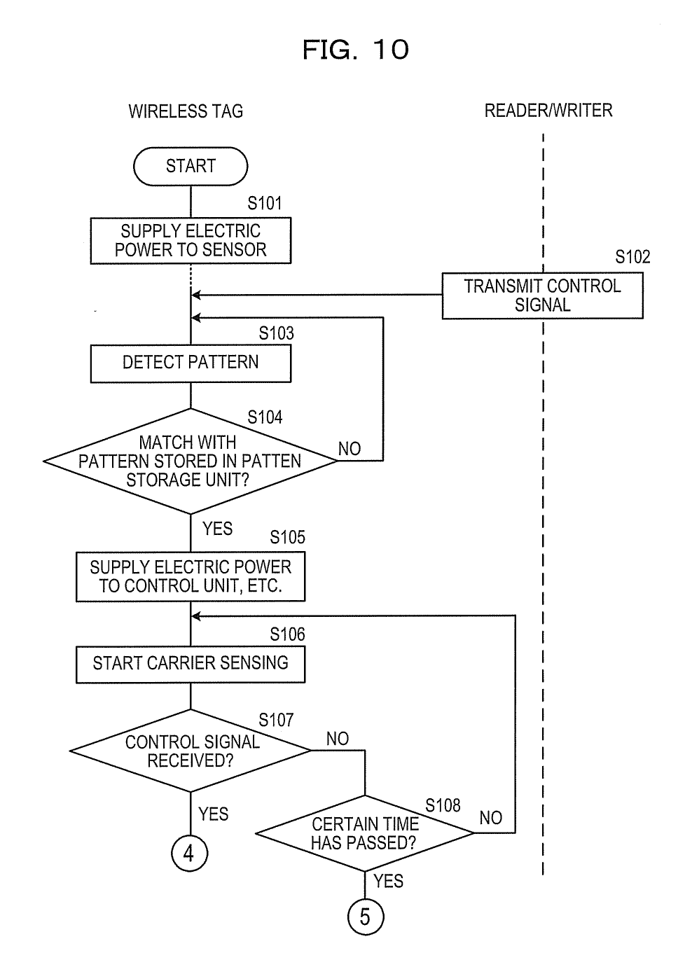

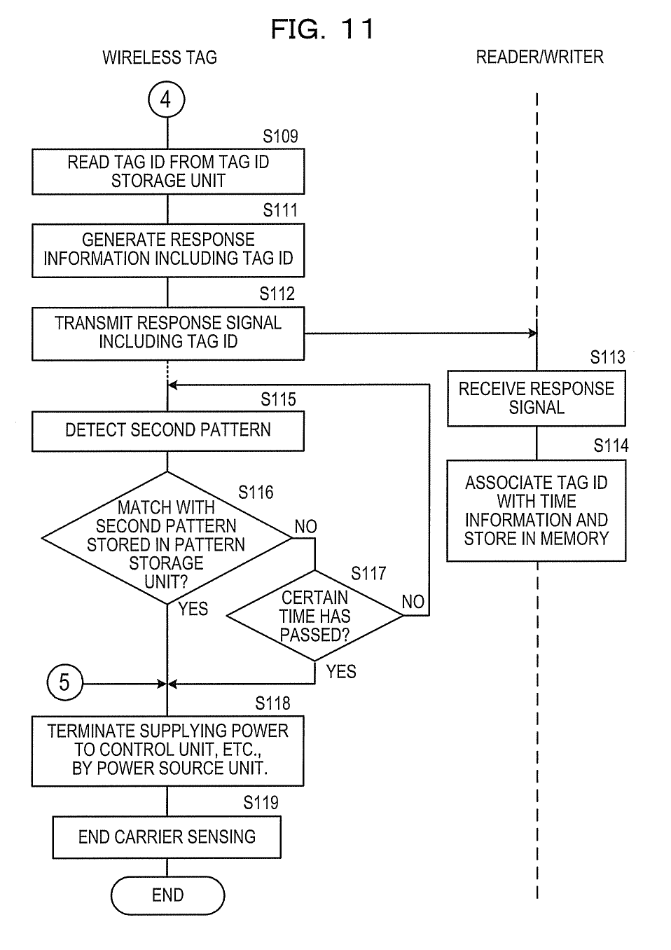

FIGS. 10 and 11 illustrate a flow chart of a procedure of transmission and reception according to the second embodiment. The power source unit 24 supplies electric power to the sensor 25 of the wireless tag 2 transferred by the conveyor belt 56 (step S101). The power of the reader/writer 1 is turned on when an activation signal is received from the computer 3. The control unit 11 of the reader/writer 1 then outputs control information to the transmitting unit 18.

The transmitting unit 18 continuously transmits a control signal after modulation through the transmission antenna 181 (step S102). The sensor 25 embedded in the wireless tag 2 performs pattern detection (step S103). The sensor 25 of the wireless tag 2 determines whether the detected pattern matches the pattern stored in the pattern storage unit 251 (step S104). If the sensor 25 determines that the patterns do not match (NO in step S104), the process returns to step S103, and the process is repeated.

On the other hand, the sensor 25 outputs an activation signal to the power source unit 24 if the sensor 25 determines that the patterns match (YES in step S104). Triggered by the reception of the activation signal, the power source unit 24 starts to supply electric power to the control unit 21, the memory 22, the generating unit 210, the decoding unit 211, the receiving unit 26, and the transmitting unit 28 (step S105). The control unit 21 starts carrier sensing by the receiving unit 26 (step S106). The receiving unit 26 determines whether a control signal is received (step S107). The receiving unit 26 reads a tag ID from the tag ID storage unit 221 (step S109) if the receiving unit 26 determines that the control signal is received (YES in step S107).

The control unit 21 causes the generating unit 210 to generate response information including the tag ID (step S111). The control unit 21 transmits a response signal including the tag ID to the reader/writer 1 through the transmitting unit 28 (step S112). The receiving unit 16 of the reader/writer 1 receives the response signal (step S113). The receiving unit 16 outputs response information after demodulation to the control unit 11. The control unit 11 associates the tag ID in the response information with time information outputted from clock unit 13 and stores the tag ID and the time information in the memory 12 (step S114). The CPU 31 of the computer 3 receives the tag ID and the time information outputted through the communication unit 36. The CPU 31 stores the tag ID and the time information in the storage unit 35.

If the receiving unit 26 determines in step S107 that the control signal is not received (NO in step S107), the control unit 21 refers to the output of the clock unit 252 to determine whether a certain time has passed after the power supply (step S108). The certain time is stored in the memory 22 and is, for example, five seconds. If the control unit 21 determines that the certain time has not passed (NO in step S108), the process returns to step S106, and the process is repeated. After step S112, the sensor 25 further detects the second pattern (step S115). The sensor 25 determines whether the detected pattern matches the second pattern stored in the pattern storage unit 251 (step S116). The process moves to step S117 described below.

On the other hand, the sensor 25 outputs a termination signal to the power source unit 24 if the sensor 25 determines that the detected pattern and the second pattern match (YES in step S116). After receiving the termination signal, the power source unit 24 terminates supplying power to the control unit 21, the memory 22, the generating unit 210, the decoding unit 211, the receiving unit 26, and the transmitting unit 28 (step S118). The power supply is terminated, and the carrier sensing by the transmitting unit 28 also ends (step S119).

If the sensor 25 determines in step S116 that the detected pattern and the second pattern do not match (NO in step S116), the sensor 25 determines whether a certain time has passed after determining in step S104 that the patterns match (step S117).

If the sensor 25 determines that the certain time has not passed (NO in step S117), the process returns to step S115, and the process is repeated. The pattern storage unit 251 of the sensor 25 stores a setting value that indicates the certain time (for example, five seconds).

If the sensor 25 determines that the certain time has passed (YES in step S117), the sensor determines that the time has run out and outputs a termination signal to the power source unit 24. The power source unit 24 terminates supplying power to the control unit 21, etc (step S118).

If the control unit 21 does not receive the control signal from the reader/writer 1 and determines in step S108 that the certain time has passed (YES in step S108), the control unit 21 outputs a termination signal to the power source unit 24. After receiving the termination signal, the power source unit 24 terminates supplying power to the control unit 21, etc (step S118). In this way, necessary information can be transmitted and received while the wireless tag 2 passes between the generating unit 50 and the second generating unit 60. The power saving can also be attained since the wireless tag 2 is turned off when the wireless tag 2 passes through the generating unit 60.

Other than the process described above, the reader/writer 1 may determine that the wireless tag 2 has passed, on the condition that the generating unit 50 generates the pattern and the second generating unit 60 generates the second pattern. The process will be described.

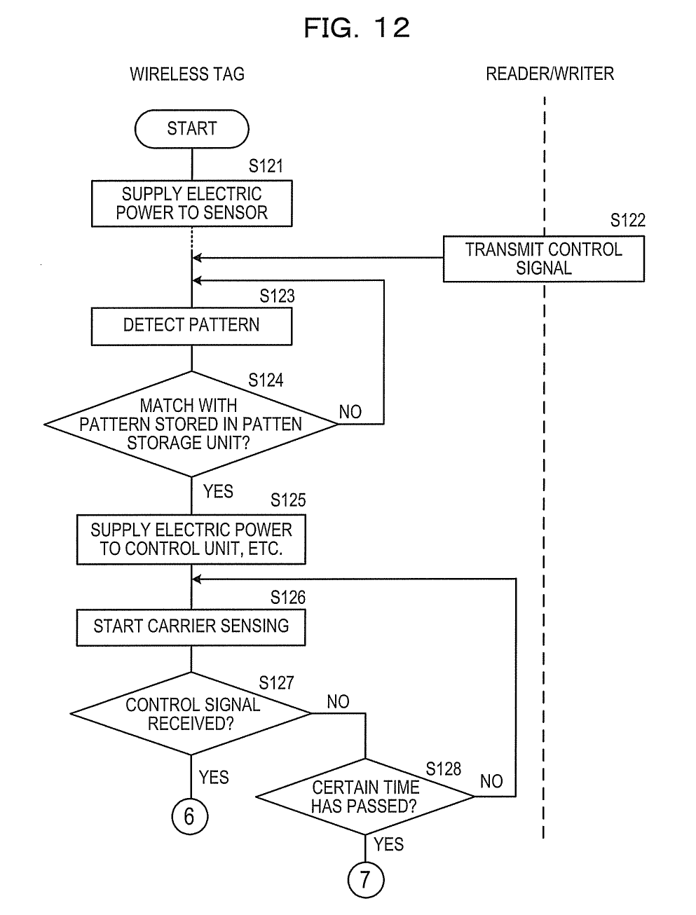

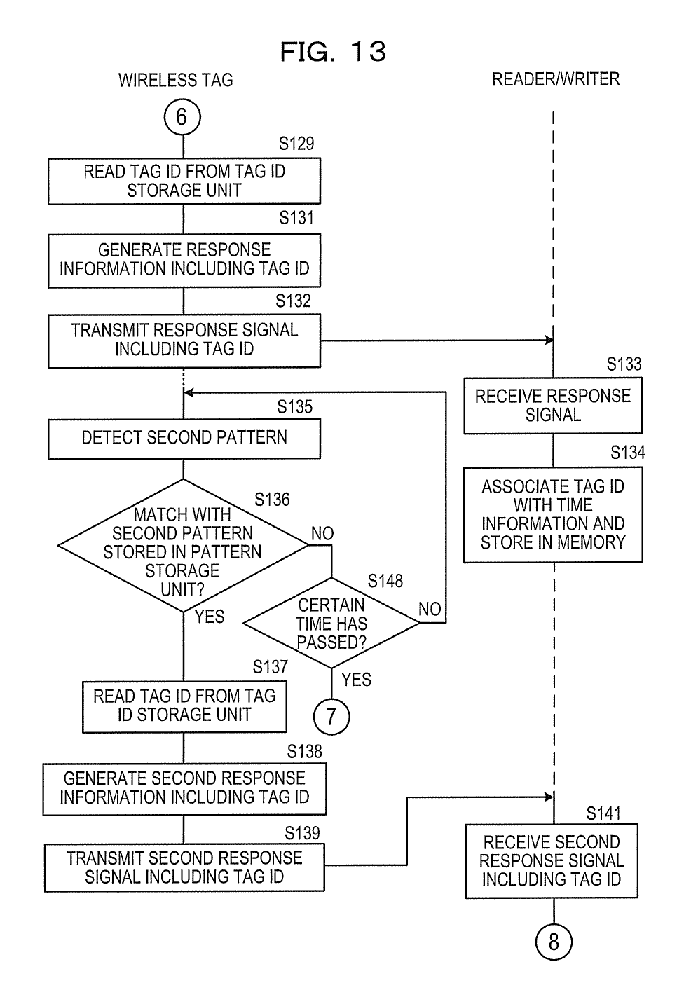

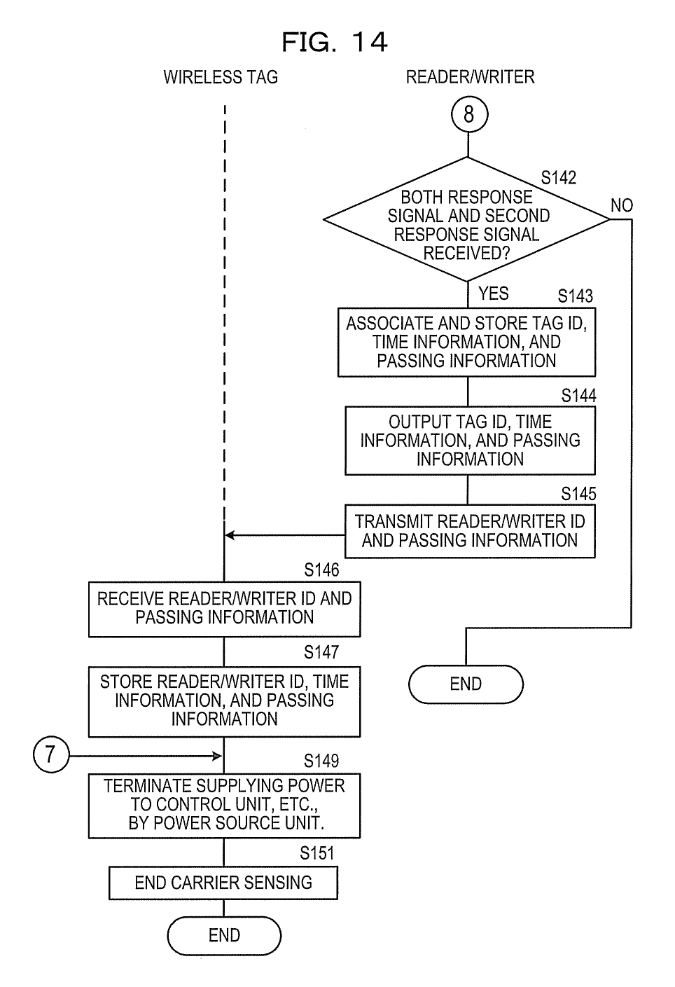

FIGS. 12 to 14 illustrate a flow chart of a procedure of a transmission and reception process. Processes from steps S121 to S132 are the same as the processes from steps S101 to S112, and the description will not be repeated.

After the pattern detection by the sensor 25, the control unit 21 transmits a response signal including a tag ID to the reader/writer 1, and the receiving unit 16 of the reader/writer 1 receives the response signal (step S133). The control unit 11 of the reader/writer 1 associates the response signal and time information outputted from the clock unit 13 and stores the response signal and the time information in the memory 12 (step S134). After step S132, the sensor 25 further detects the second pattern (step S135). The sensor 25 determines whether the detected pattern matches the second pattern stored in the pattern storage unit 251 (step S136). If the sensor 25 determines that the patterns do not match (NO in step S136), the process moves to step S148 described below.

On the other hand, if the sensor 25 determines that the detected pattern and the second pattern match (YES in step S136), the sensor 25 reads a tag ID from the tag ID storage unit 221 (step S137). The control unit 21 further generates second response information including the tag ID (step S138). The second response information additionally includes information indicating that the second pattern is detected. The control unit 21 transmits a generated second response signal including the tag ID to the reader/writer 1 (step S139). The control unit 11 of the reader/writer 1 receives the second response signal including the tag ID (step S141).

The control unit 11 determines whether both the response signal received in step S133 and the second response signal received in step S141 are received (step S142). If the control unit 11 determines that both the response signal and the second response signal are not received (NO in step S142), the control unit 11 determines that the wireless tag 2 has not correctly passed through and ends the process.

On the other hand, if the control unit 11 determines that both the response signal and the second response signal are received (YES in step S142), the control unit 11 associates the tag ID, time information outputted from the clock unit 13, and passing information indicating that the wireless tag 2 has passed and stores the tag ID, the time information, and the passing information in the memory 12 (step S143). The control unit 11 outputs the stored tag ID, the time information, and the passing information to the computer 3 (step S144). The CPU 31 of the computer 3 stores the tag ID, the time information, and the passing information in the storage unit 35.

The control unit 11 reads a unique reader/writer ID for identifying the reader/writer 1. The control unit 11 transmits the time information, the reader/writer ID, and the passing information to the wireless tag 2 through the transmitting unit 18 (step S145). This is for informing the wireless tag 2 that the wireless tag 2 has correctly passed through the generating unit 50 and the second generating unit 60 near the reader/writer 1. Instead of transmitting the reader/writer ID of the reader/writer 1, location information (such as latitude and longitude) indicating the location where the reader/writer 1 is installed may be transmitted.

The control unit 21 of the wireless tag 2 receives the reader/writer ID and the passing information (step S146). The control unit 21 of the wireless tag 2 stores the received reader/writer ID, the time information, and the passing information in the memory 22 (step S147). In step S136, if the sensor 25 determines that the pattern does not match the second pattern (NO in step S136), the sensor 25 determines whether a certain time has passed (step S148). If the sensor 25 determines that the certain time has not passed (NO in step S148), the process returns to step S135.

After the process of step S147, if a certain time has passed in step S128 and if the sensor 25 determines in step S148 that a certain time has passed (YES in step S148), the sensor 25 outputs a termination signal to the power source unit 24. After receiving the termination signal, the power source unit 24 terminates supplying power to the control unit 21, the memory 22, the generating unit 210, the decoding unit 211, the receiving unit 26, and the transmitting unit 28 (step S149). The power supply is terminated, and the carrier sensing by the transmitting unit 28 also ends (step S151). In this way, the wireless tag 2 that has passed only the generating unit 50 and has been transferred to another transfer path can be determined as a wireless tag 2 that has not passed through.

The configuration of the present second embodiment is as described above, and other parts are the same as in the first embodiment. Corresponding parts are designated with the same reference numerals and the detailed descriptions will not be repeated.

### Third Embodiment

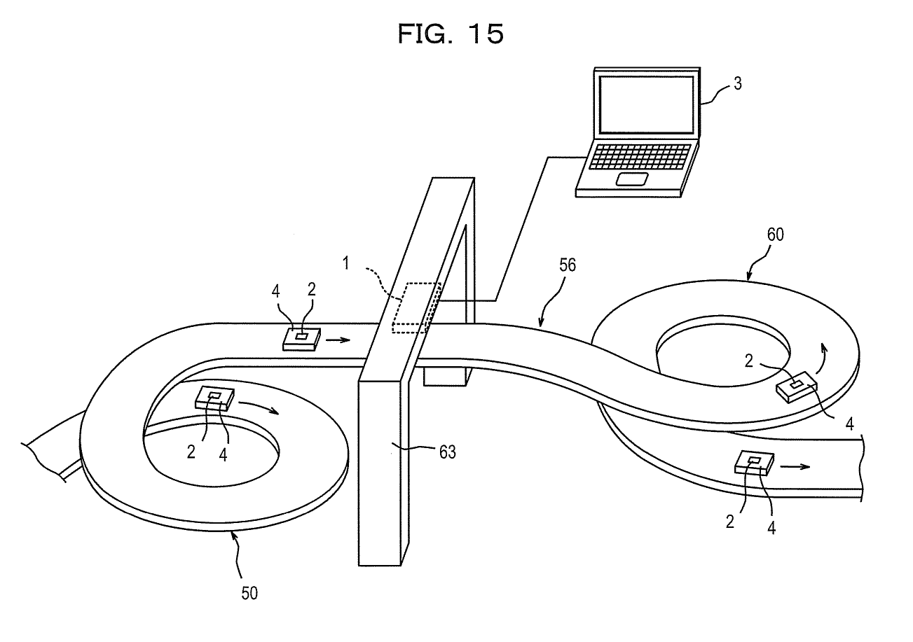

A third embodiment relates to another generating unit 50 and second generating unit 60. FIG. 15 is a schematic diagram of an overview of a control system according to the third embodiment.

The control system according to the third embodiment includes the generating unit 50, the second generating unit 60, a gate 63, the reader/writer 1, the computer 3, the commodity 4, the conveyor belt 56, the wireless tag 2, etc. The conveyor belt 56 transfers the commodity 4 pasted with the wireless tag 2. The conveyor belt 56 comprises the generating unit 50 that rotates the commodity 4 clockwise in the upstream and the second generating unit 60 that rotates the commodity 4 counterclockwise in the downstream. The gate 63 is constructed on the conveyor belt 56 between the generating unit 50 and the second generating unit 60. The reader/writer 1 is placed at the approximate center of the gate 63 over the conveyor belt 56.

The generating unit 50 and the second generating unit 60 are arranged near the reader/writer 1, and the wireless tag 2 transferred over the generating unit 50 or the second generating unit 60 can transmit and receive signals to and from the reader/writer 1. The wireless tag 2 includes the sensor 25, such as an acceleration sensor and a gyro sensor, and detects the pattern and the second pattern generated by the generating unit 50 and the second generating unit 60. The generating unit 50 rotates the wireless tag 2 clockwise within a given time.

The sensor 25 detects the clockwise rotation within the given time and outputs an activation signal to the power source unit 24. This leads the wireless tag 2 to start communication (transmission and reception of signals) with the reader/writer 1 under the control of the control unit 21. The second generating unit 60 rotates the wireless tag 2 counterclockwise within a given time. The sensor 25 detects the counterclockwise rotation within the given time and outputs a termination signal to the power source unit 24. This leads the wireless tag 2 to end communicating with the reader/writer 1.

The generating unit 50 may make a counterclockwise rotation, and the second generating unit 60 may make a clockwise rotation. The given times are stored in advance in the memory 22, and appropriate values can be set according to the transfer speed of the conveyor belt 56 and the lengths of the transfer paths of the generating unit 50 and the second generating unit 60. For example, the given times can be five seconds.

Without installing the second generating unit 60, the sensor 25 or the control unit 21 may output a termination signal to the power source unit 24 after the output of the activation signal by the generating unit 50 to end the communication. Furthermore, the reader/writer 1 may store the tag ID and the passing information of the wireless tag 2 on the condition that the response signal based on the pattern detection by the generating unit 50 and the second response signal based on the second pattern detection by the second generating unit 60 are received, as described in the second embodiment. Only the generating unit 50 may be installed without installing the second generating unit 60. The sensor 25 outputs a termination signal to the power source unit 24 after a certain time after the pattern detection by the generating unit 50. In this way, the pattern generated by the wireless tag 2 can be detected within a given time. Collisions of the wireless tags 2 can also be reduced at places such as airports where a multiplicity of commodities 4 are transferred.

The configuration of the present third embodiment is as described above, and other parts are the same as in the first and second embodiments. Corresponding parts are designated with the same reference numerals and the detailed descriptions will not be repeated.

### Fourth Embodiment

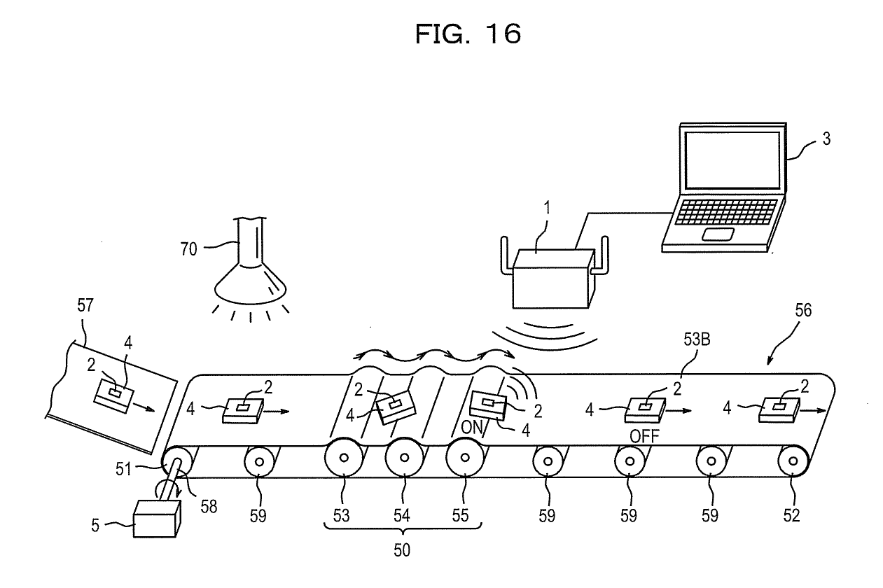

A fourth embodiment relates to a configuration in which an auxiliary generating unit is installed. FIG. 16 is a schematic diagram of an overview of a control system according to the fourth embodiment.

An auxiliary generating unit 70 that generates an auxiliary pattern, which is a different pattern, is arranged in the upstream in the transfer direction of the generating unit 50. An LED (Light-Emitting Diode) 70 that emits light according to a given auxiliary pattern is used in an example described in the present embodiment. In place of the LED 70, the conveyor belt 56 that rotates clockwise described in the third embodiment may be arranged as the auxiliary generating unit 70 in the upstream of the generating unit 50. The auxiliary generating unit 70 does not have to be arranged near the reader/writer 1.

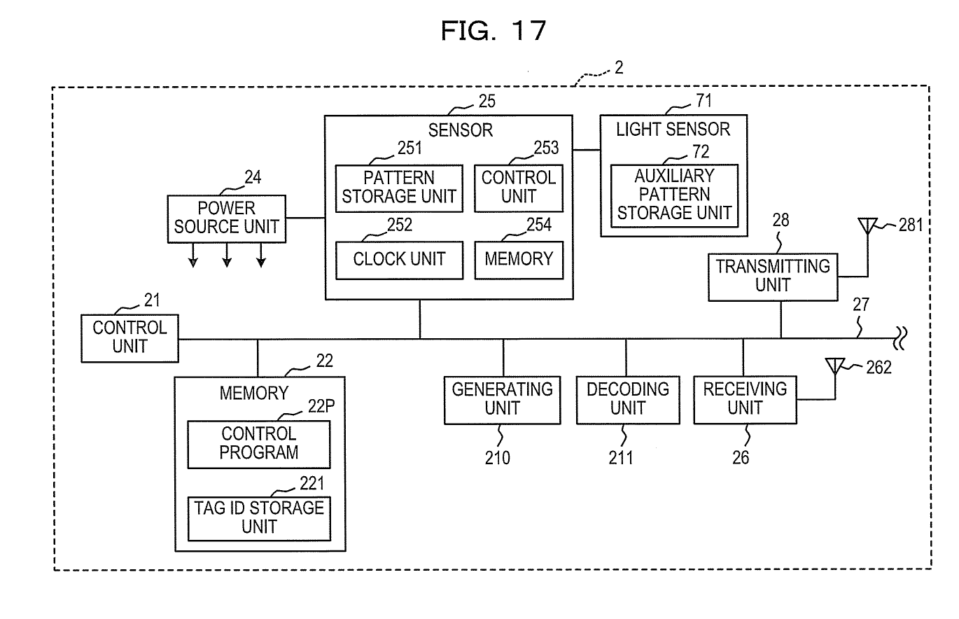

FIG. 17 is a block diagram of hardware of the wireless tag 2 according to the fourth embodiment. A light sensor 71 as an auxiliary sensor is installed in addition to the first embodiment. In other words, a sensor that is a different type from the sensor 25 is applied as the auxiliary sensor. The light sensor 71 stores an auxiliary pattern in an auxiliary pattern storage unit 72, the auxiliary pattern different from the pattern described in the first embodiment.

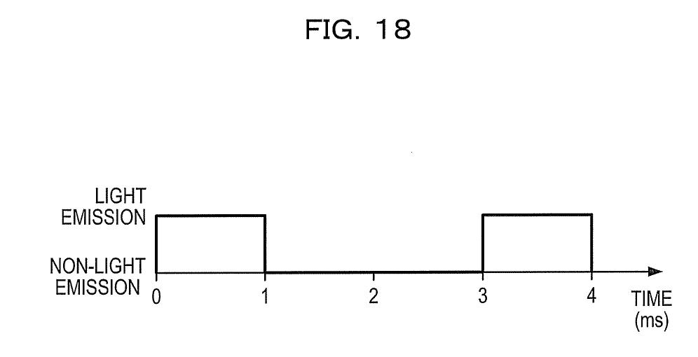

FIG. 18 is a time chart of a transition of light emission or non-light emission of the LED 70. The horizontal axis denotes time in FIG. 18, and the unit is ms. The vertical axis denotes light emission or non-light emission of the LED 70. A control unit not shown performs PWM (Pulse-Width Modulation) control of the LED 70. The control unit turns on or off the LED 70 according to the given auxiliary pattern. The LED 70 emits light as an auxiliary pattern for a given time at a given period. The example of FIG. 18 illustrates an auxiliary pattern in which the light is emitted for 1 ms with a period of 3 ms, and the light is not emitted in the remaining 2 ms.

The power source unit 24 continuously supplies electric power to the light sensor 71 in the same way as to the sensor 25. If the light sensor 71 determines that the detected light matches the auxiliary pattern stored in the auxiliary pattern storage unit 72, the light sensor 71 outputs an auxiliary activation signal to the sensor 25. A control unit 253 of the sensor 25 refers to the output of the clock unit 252 and stores the time that the light sensor 71 has detected the auxiliary pattern (hereinafter, “auxiliary detection time”) in a memory 254. Although an example of generating a pattern by light is described in the present embodiment, the arrangement is not limited to this. For example, a speaker may be used in place of the LED to generate a sound pattern. In that case, a microphone, etc., is used as the auxiliary sensor.

The order of detecting the pattern and the auxiliary pattern may be opposite in the configuration. In other words, the pattern may be detected first, and the auxiliary pattern may be detected later. The sensor 25 then detects a pattern generated by the generation rollers 53, 54, and 55. If the sensor 25 determines that the pattern matches the pattern stored in the pattern storage unit 251, the sensor 25 determines whether an auxiliary activation signal from the light sensor 71 is outputted. If it is determined that the auxiliary activation signal is outputted, the control unit 253 refers to the output of the clock unit 252 and acquires the time (detection time) that the sensor 25 has detected the pattern.

The control unit 253 determines whether the interval (hereinafter, “difference”) between the auxiliary detection time stored in the memory 254 and the detection time is within a given time (for example, three seconds) stored in the memory 254. The control unit 253 outputs an activation signal to the power source unit 24 on the condition that the difference is within the given time. In this way, the electric power is supplied to the control unit 21 of the wireless tag 2, etc., and the communication with the reader/writer 1 starts.

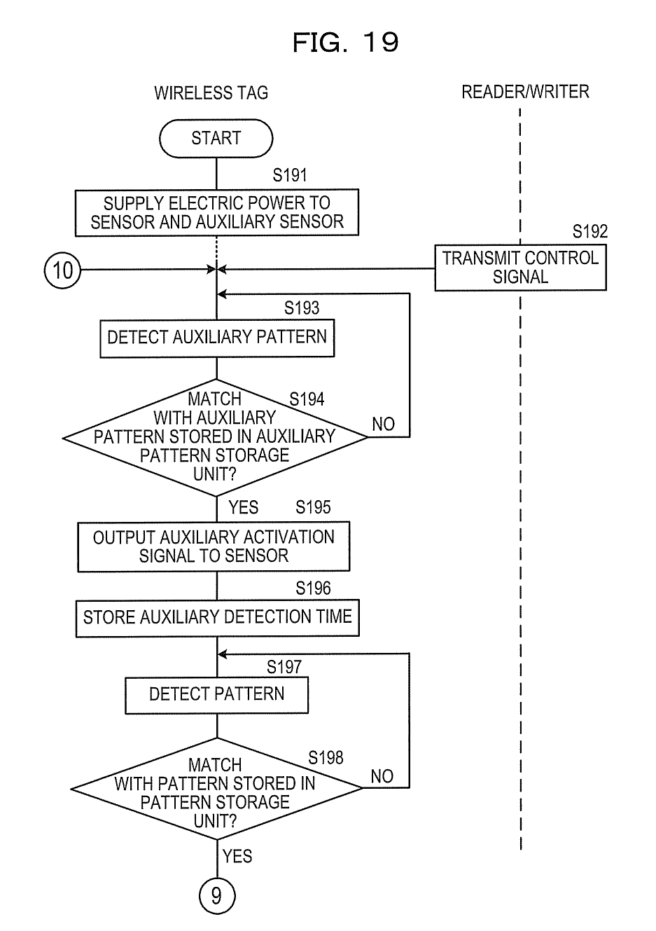

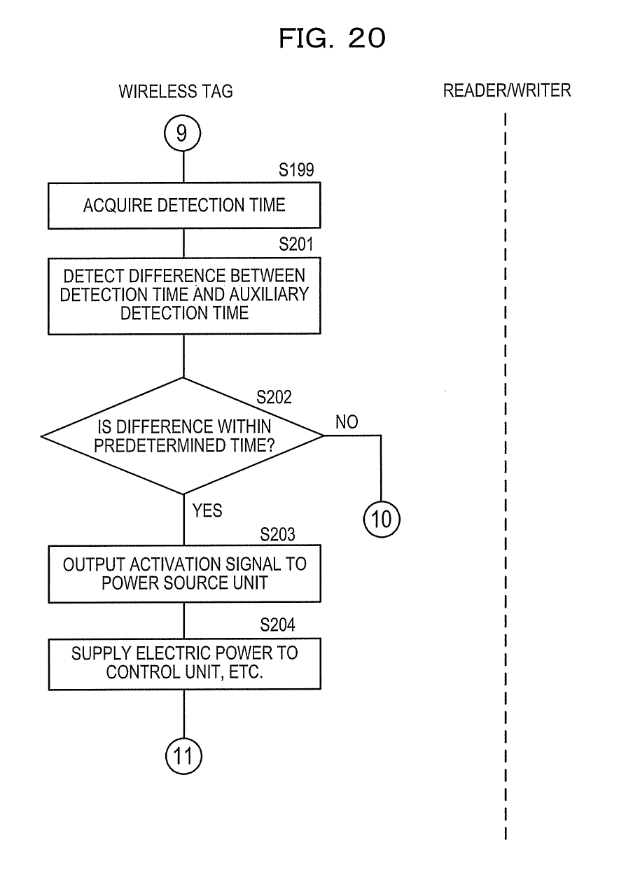

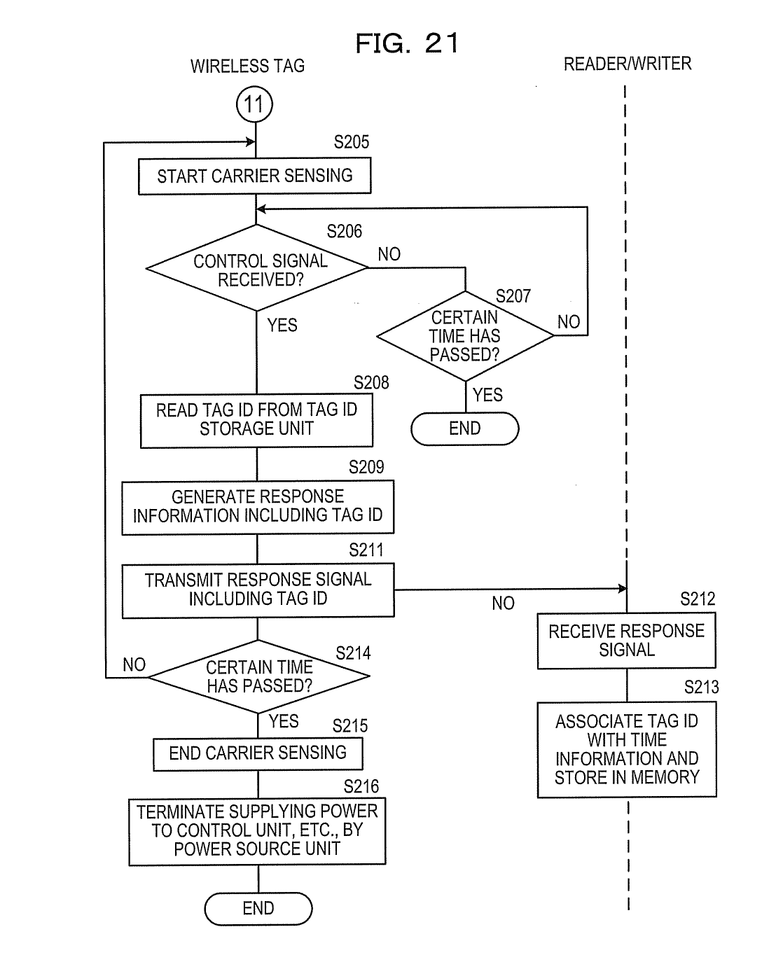

FIGS. 19 to 21 illustrate a flow chart of a procedure using a pattern and an auxiliary pattern. The power source unit 24 of the wireless tag 2 transferred by the conveyor belt 56 supplies electric power to the sensor 25 and the auxiliary sensor 71 (step S191). The power of the reader/writer 1 is turned on when an activation signal from the computer 3 is received. The control unit 11 of the reader/writer 1 then generates control information in the generating unit 110 and outputs the generated control information to the transmitting unit 18. The transmitting unit 18 continuously transmits a control signal after modulation through the transmission antenna 181 (step S192). The LED 70 repeats lighting and non-lighting according to the auxiliary pattern. An auxiliary sensor 71 embedded in the wireless tag 2 detects an auxiliary pattern (step S193).

The light sensor 71 determines whether the detected auxiliary pattern matches the auxiliary pattern stored in the auxiliary pattern storage unit 72 (step S194). If the light sensor 71 determines that the patterns do not match (NO in step S194), the process moves to step S193, and the process is repeated. If the light sensor 71 determines that the patterns match (YES in step S194), the light sensor 71 outputs an auxiliary activation signal to the sensor 25 (step S195).

The sensor 25 refers to time information outputted from the clock unit 252 and stores the time information in the memory 254 as auxiliary detection time (step S196). The sensor 25 detects a pattern on the condition that the auxiliary pattern is detected (step S197). The sensor 25 determines whether the detected pattern matches the pattern stored in the pattern storage unit 251 (step S198). If the sensor 25 determines that the patterns do not match (NO in step S198), the process moves to step S197, and the process is repeated. If the sensor 25 determines that the patterns match (YES in step S198), the sensor 25 acquires a detection time based on the time outputted from the clock unit 252 (step S199).

The control unit 253 reads an auxiliary detection time from the memory 254. The control unit 253 then detects a difference between the detection time and the auxiliary detection time (step S201). The control unit 253 reads a given time stored in the memory 254. The control unit 253 determines whether the difference is within the read given time (step S202). If the control unit 253 determines that the difference is not within the given time (NO in step S202), the process returns to step S193. The process of step S202 does not have to be arranged.

If the control unit 253 determines that the difference is within the given time (YES in step S202), the control unit 253 outputs an activation signal to the power source unit 24 (step S203). Triggered by the reception of the activation signal, the power source unit 24 starts to supply electric power to the control unit 21, the memory 22, the generating unit 210, the decoding unit 211, the receiving unit 26, and the transmitting unit 28 (step S204).

The control unit 21 starts carrier sensing by the receiving unit 26 (step S205). The receiving unit 26 determines whether a control signal is received (step S206). If the receiving unit 26 determines that the control signal is not received (NO in step S206), the control unit 21 refers to the output of the clock unit 252 and determines whether a certain time has passed after the start of the carrier sensing (step S207). If the control unit 21 determines that the certain time has not passed (NO in step S207), the process returns to step S206, and the process is repeated.

On the other hand, if the control unit 21 determines that the certain time has passed (YES in step S207), the control unit 21 determines that the time has run out and ends the process. In that case, the control unit 21 outputs a termination signal to the power source unit 24. The power source unit 24 terminates supplying power to the control unit 21, etc. This also ends the carrier sensing by the receiving unit 26.

The receiving unit 26 reads a tag ID from the tag ID storage unit 221 (step S208) if the receiving unit 26 determines that the control signal is received (YES in step S206). The control unit 21 causes the generating unit 210 to generate response information including the tag ID (step S209). The control unit 21 outputs the generated response information including the tag ID to the transmitting unit 28. The transmitting unit 28 modulates the response information and transmits a response signal after modulation to the reader/writer 1 (step S211). The receiving unit 16 of the reader/writer 1 receives the response signal (step S212). The receiving unit 16 outputs response information after demodulation to the control unit 11.

The control unit 11 associates the tag ID in the response information and the time information outputted from the clock unit 13 and stores the tag ID and the time information in the memory 12 (step S213). The reader/writer 1 outputs the stored tag ID and the time information to the computer 3 upon every reception or every certain time (for example, every hour). The CPU 31 of the computer 3 receives the tag ID and the time information outputted through the communication unit 36. The CPU 31 stores the tag ID and the time information in the storage unit 35.

After step S211, the control unit 21 of the wireless tag 2 refers to the output of the clock unit 252 and determines whether a certain time has passed after the electric power is supplied in step S204 or after the start of the carrier sensing in step S205 (step S214). If the control unit 21 determines that the certain time has not passed (NO in step S214), the process moves to step S205, and the process is repeated. If the control unit 21 determines that the certain time has passed (YES in step S214), the control unit 21 outputs a termination signal of carrier sensing to the transmitting unit 28. After receiving the termination signal, the transmitting unit 28 ends the carrier sensing (step S215). The control unit 21 outputs the termination signal to the power source unit 24.

After receiving the termination signal, the power source unit 24 terminates supplying power to the control unit 21, the memory 22, the generating unit 210, the decoding unit 211, the receiving unit 26, and the transmitting unit 28 (step S216). In this way, the wireless tag 2 starts communication on the condition that the auxiliary pattern and the pattern match. Therefore, an improper start of communication by the wireless tag 2 can be prevented. More accurate management of the power source of the wireless tag 2 is possible by limiting the time between the matching of the auxiliary patterns and the matching of the patterns. As a result, further power saving can be attained.

The configuration of the present fourth embodiment is as described above, and other parts are the same as in the first to third embodiments. Corresponding parts are designated with the same reference numerals and the detailed descriptions will not be repeated.

### Fifth Embodiment

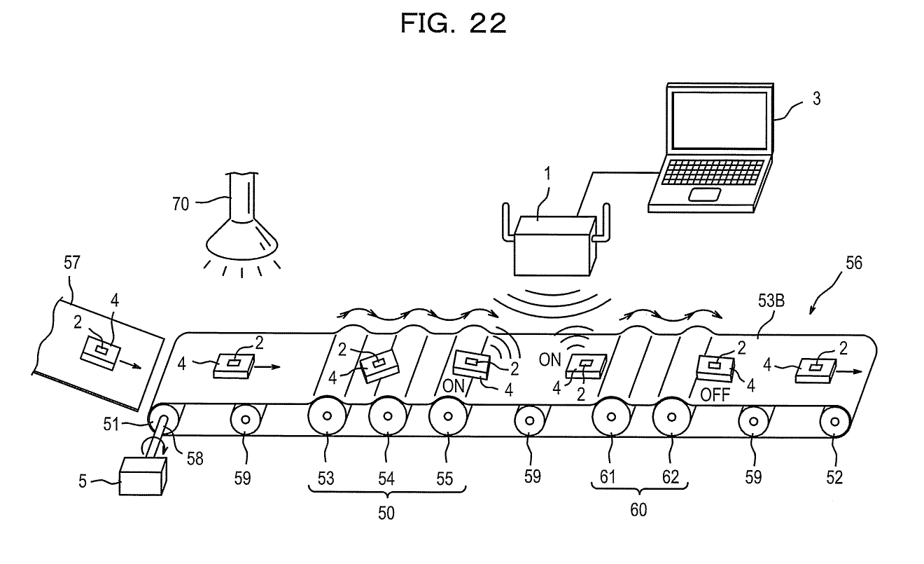

A fifth embodiment relates to a configuration in which the second generating unit 60 described in the second embodiment is added to the fourth embodiment. FIG. 22 is a schematic diagram of an overview of a control system according to the fifth embodiment.

The control system comprises the auxiliary generating unit 70 and the generating unit 50 in the downstream in the transfer direction and comprises the second generating unit 60 in the further downstream of the reader/writer 1. An appropriate combination of the generation rollers 53 and 61, the LED 70, the triangular prisms 53 and 61, the conveyor belt 56 that rotates clockwise, the conveyor belt 56 that rotates counterclockwise, etc., can be used for the auxiliary generating unit 70, the generating unit 50, and the second generating unit 60.

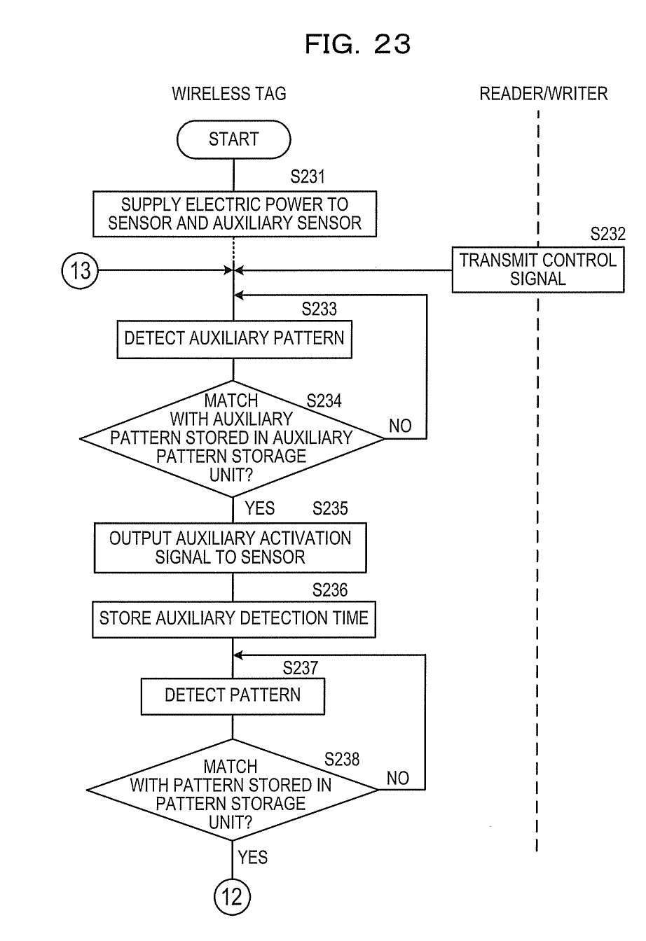

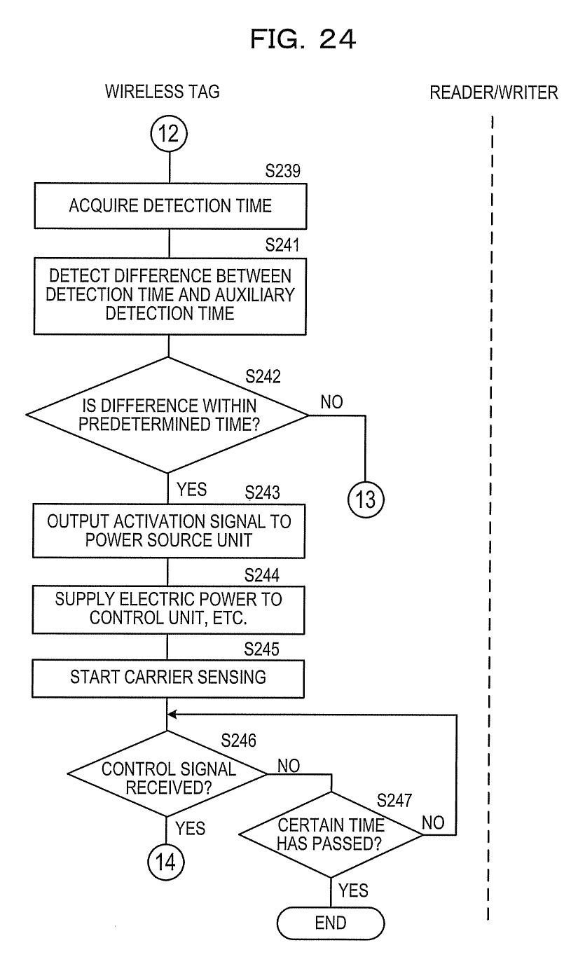

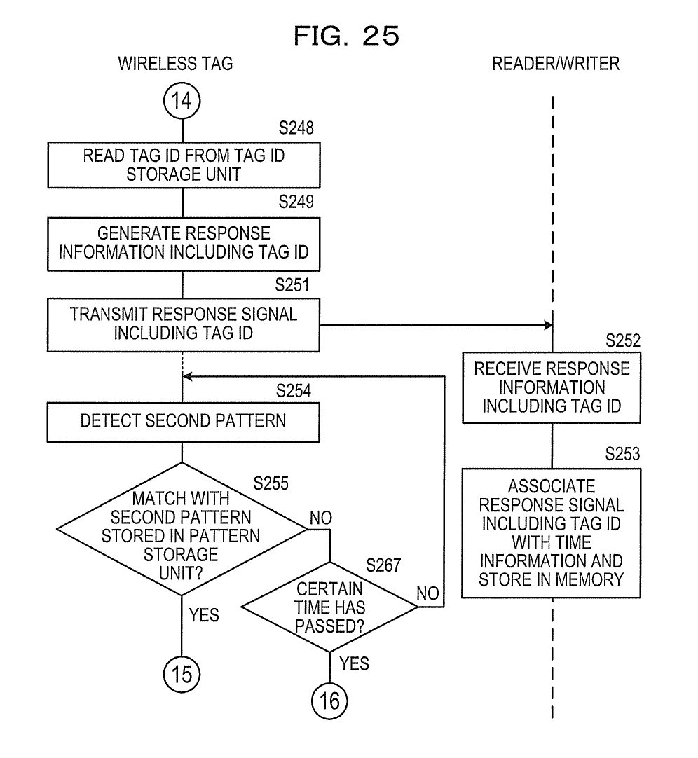

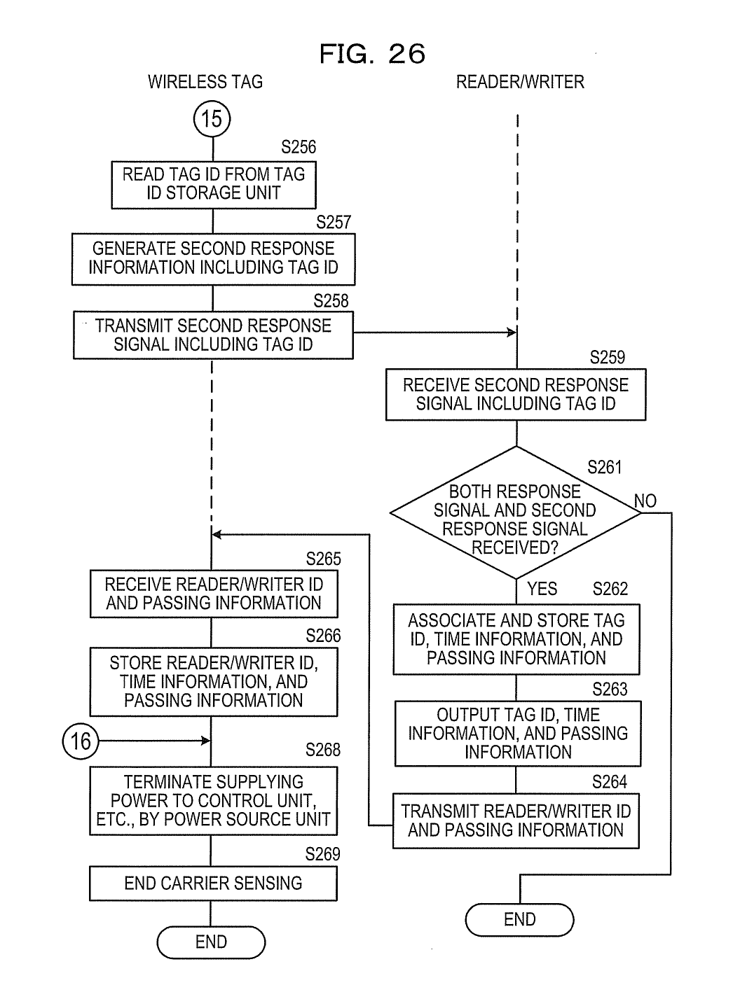

FIGS. 23 to 26 illustrate a flow chart of a procedure using a pattern, an auxiliary pattern, and a second pattern. Since the processes of steps S231 to S251 are the same as steps S191 to S211 described in the fourth embodiment, the detailed description will not be repeated. The following process is executed after the completion of the detections of the auxiliary pattern and the pattern and the reception of the control signal described in the fourth embodiment.

The control unit 11 of the reader/writer 1 receives a response signal including the tag ID transmitted from the wireless tag 2 through the receiving unit 16 (step S252). The control unit 11 associates the received response signal including the tag ID with time information outputted from the clock unit 13 and stores the response signal and the time information (step S253).

After step S251, the sensor 25 further detects a second pattern (step S254). The sensor 25 determines whether the detected pattern and the second pattern stored in the pattern storage unit 251 match (step S255). If the sensor 25 determines that the patterns do not match (NO in step S255), the process moves to step S267 described below.

On the other hand, if the sensor 25 determines that the second patterns match (YES in step S255), the sensor 25 reads a tag ID from the tag ID storage unit 221 (step S256). The control unit 21 further generates second response information including the tag ID (step S257). The second response information additionally includes information indicating that the second pattern is detected. The control unit 21 transmits a generated second response signal including the tag ID to the reader/writer 1 (step S258).

The control unit 11 of the reader/writer 1 receives the second response signal including the tag ID (step S259). The control unit 11 determines whether both the response signal received in step S252 and the second response signal received in step S259 are received (step S261). If the control unit 11 determines that both the response signal and the second response signal are not received (NO in step S261), the control unit 11 determines that the wireless tag 2 has not correctly passed through and ends the process.

On the other hand, if the control unit 11 determines that both the response signal and the second response signal are received (YES in step S261), the control unit 11 associates and stores the tag ID, time information outputted from the clock unit 13, and passing information indicating that the wireless tag has passed in the memory 12 (step S262). The control unit 11 outputs the stored tag ID, time information, and passing information to the computer 3 (step S263). The CPU 31 of the computer 3 stores the tag ID, the time information, and the passing information in the storage unit 35.

The control unit 11 reads a unique reader/writer ID for identifying the reader/writer 1. The control unit 11 transmits the time information, the ID of the reader/writer, and the passing information to the wireless tag 2 through the transmitting unit 18 (step S264). The control unit 21 of the wireless tag 2 receives the reader/writer ID and the passing information (step S265). The control unit 21 of the wireless tag 2 stores the received reader/writer ID, the time information, and the passing information in the memory 22 (step S266).

On the other hand, if the sensor 25 determines in step S255 that the pattern does not match the second pattern (NO in step S255), the sensor 25 determines whether a certain time has passed (step S267). If the sensor 25 determines that the certain time has not passed (NO in step S267), the process returns to step S254. After the process of step S266 and if the sensor 25 determines in step S267 that the certain time has passed (YES in step S267), the sensor 25 outputs a termination signal to the power source unit 24.

After receiving the termination signal, the power source unit 24 terminates supplying electric power to the control unit 21, the memory 22, the generating unit 210, the decoding unit 211, the receiving unit 26, and the transmitting unit 28 (step S268). The power supply is terminated, and the carrier sensing by the transmitting unit 28 also ends (step S269). In this way, the commodity 4 requiring high-level management related to reading or writing of the wireless tag 2 can be appropriately managed. The power saving can also be attained since a collision or an unnecessary operation can be reduced.

The configuration of the present fifth embodiment is as described above, and other parts are the same as in the first to fourth embodiments. Corresponding parts are designated with the same reference numerals and the detailed descriptions will not be repeated.

### Sixth Embodiment

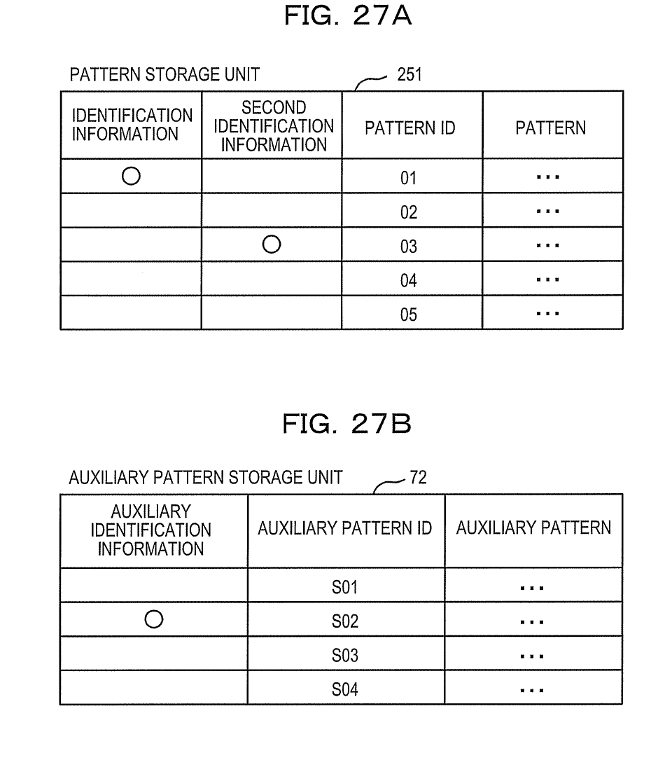

A sixth embodiment relates to a configuration for selecting a pattern, a second pattern, and an auxiliary pattern. FIG. 27A is an explanatory view of record layouts of the pattern storage unit 251. FIG. 27B is an explanatory view of record layouts of the auxiliary pattern storage unit 72.

The reader/writer 1 can write the pattern to be stored in the pattern storage unit 251. A plurality of patterns may be stored in advance in the pattern storage unit 251 when the wireless tag 2 is manufactured, and some of the patterns may be selected. An example of selecting one of the patterns will be described.

Other than changing only the pattern, the second pattern and the auxiliary pattern may also be selected in the same way as described in the present embodiment. FIG. 27A is an explanatory view of a record layout of the pattern storage unit 251.

The pattern storage unit 251 includes an identification information field, a second identification information field, a pattern ID field, and a pattern field. The identification information denotes information for identifying one of a plurality of patterns. Different patterns are associated with a plurality of pattern IDs and stored in the pattern ID field and the pattern field of the pattern storage unit 251. The patterns are generated by the generation roller 53, etc., described in the first embodiment, and for example, different patterns in which the vertical movements are three times, four times, five times, etc., are stored. The user uses the computer 3 to input identification information according to the installation situation of the generating unit 50.

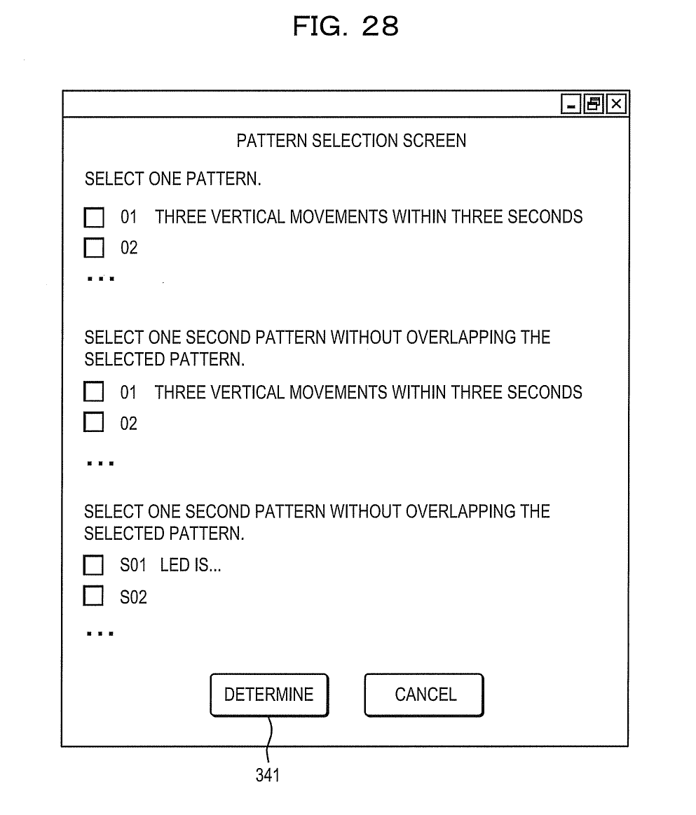

FIG. 28 is an explanatory view of an image of a pattern selection screen. The user executes the control program 35P of the computer 3. The CPU 31 reads out a pattern selection screen stored in the storage unit 35 and displays the screen on the display unit 34. The display unit 34 displays a screen for specifying one of a plurality of patterns. The user inputs identification information of a desired pattern through the input unit 33. The pattern selection screen displays check boxes, pattern IDs, and descriptions indicating detailed contents of the patterns. The patterns are expressed in text in the example described in the present embodiment. However, the CPU 31 may play a video file indicating the movements of patterns stored in the storage unit 35. The CPU 31 receives the identification information through the input unit 33.

In the identification information field of FIG. 27A, a flag is set to the record of the pattern ID related to the identification information selected by the user. The sensor 25 reads the pattern set with a flag in the identification information field stored in the pattern storage unit 251 to determine whether the patterns of step S238, etc., match. The sensor 25 outputs an activation signal to the power source unit 24 on the condition that the sensor 25 determines that the pattern matches the pattern set with a flag. This starts the communication between the wireless tag 2 and the reader/writer 1.

The user inputs second identification information of a second pattern in the same way through the input unit 33. In that case, the user prevents the pattern and the second pattern from overlapping when inputting the second identification information. The second identification information denotes information for identifying the second pattern from a plurality of patterns. The CPU 31 receives the second identification information through the input unit 33.

In the second identification information field of FIG. 27A, a flag is set to the record of the pattern ID related to the second identification information selected by the user. The flags are illustrated by white circles. The sensor 25 reads the second pattern set with a flag in the second identification information field stored in the pattern storage unit 251 to determine whether a pattern and the second pattern match in step S255, etc.

FIG. 27B is an explanatory view of a record layout of the auxiliary pattern storage unit 72. The auxiliary pattern storage unit 72 includes an auxiliary identification information field, an auxiliary pattern ID field, and an auxiliary pattern field. The auxiliary identification information denotes information for identifying the auxiliary pattern from a plurality of patterns. The auxiliary pattern ID field and the auxiliary pattern field store IDs for identifying the auxiliary patterns and the auxiliary patterns.

It is preferable to store a plurality of auxiliary patterns that can be detected by the auxiliary sensor 71, which is a different type from the sensor 25 that detects the patterns illustrated in FIG. 27A. For example, light emission patterns of the LED 70 are stored.

As shown in FIG. 28, the user inputs auxiliary identification information of a desired auxiliary pattern through the input unit 33. The CPU 31 receives the auxiliary identification information inputted through the input unit 33.

In the auxiliary identification information field of FIG. 27B, a flag is set to the record of the pattern ID related to the auxiliary identification information selected by the user. The auxiliary sensor 71 reads the auxiliary pattern set with a flag in the auxiliary identification information field stored in the auxiliary pattern storage unit 71 to determine whether the pattern and the auxiliary pattern match in step S234, etc.

If a determination button 341 is inputted from the input unit 33, the CPU 31 receives the identification information related to the pattern ID, the second identification information related to the second pattern, and the auxiliary identification information related to the auxiliary pattern. The identification information includes pattern IDs, the second identification information also includes pattern IDs, and the auxiliary identification information includes auxiliary pattern IDs.

The CPU 31 outputs the received identification information, the second identification information, and the auxiliary identification information to the reader/writer 1 through the communication unit 36. The control unit 11 of the reader/writer 1 receives the identification information, the second identification information, and the auxiliary identification information through the communication unit 14. After the communication with the wireless tag 2 is established, the control unit 11 transmits the information to the wireless tag 2 through the transmitting unit 18.

The control unit 21 of the wireless tag 2 stores the received identification information and the second identification information in the pattern storage unit 251. The control unit 21 stores the received auxiliary identification information in the auxiliary pattern storage unit 72.

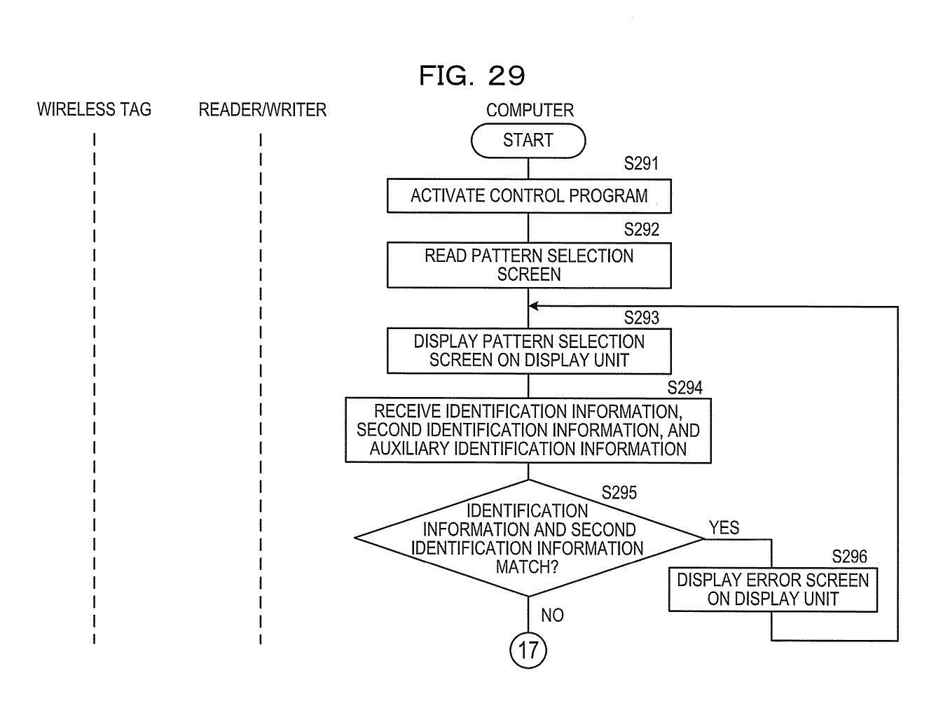

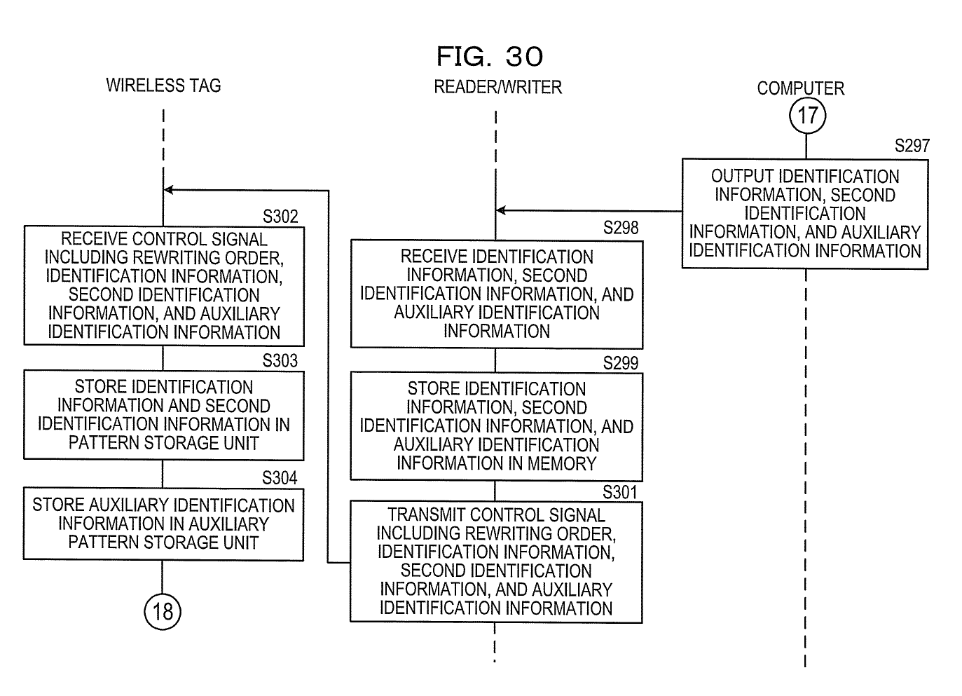

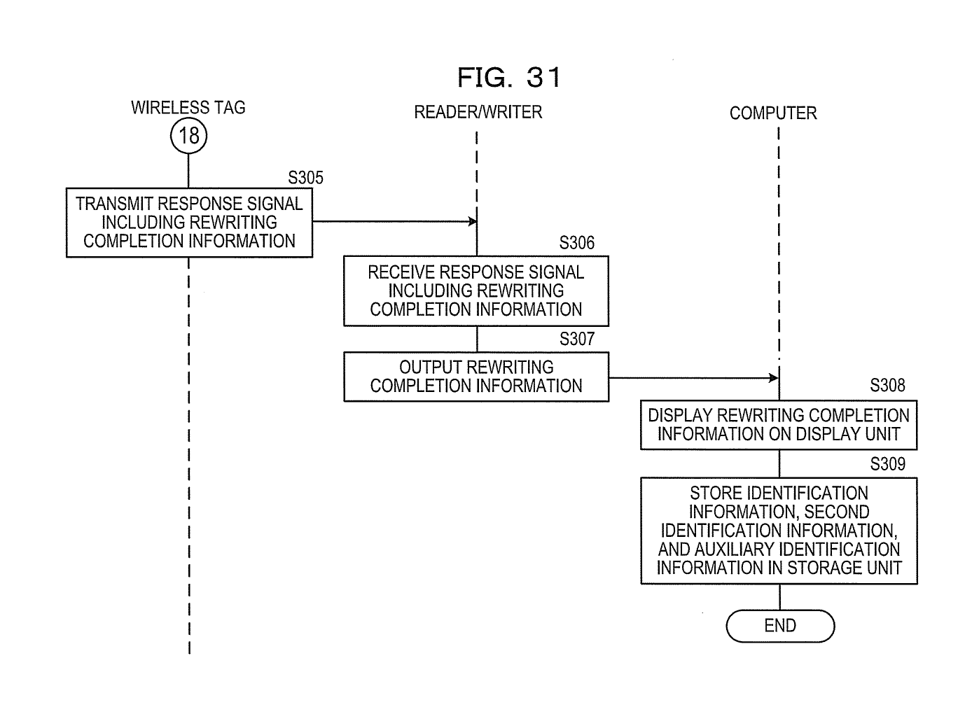

FIGS. 29 to 31 illustrate a flow chart of a procedure of pattern registration. The CPU 31 of the computer 3 receives a startup order of the control program 35P from the input unit 33. The CPU 31 launches the control program 35P when the startup order is received (step S291). The CPU 31 reads out the pattern selection screen illustrated in FIG. 28 from the storage unit 35 (step S292). The CPU 31 displays the read selection screen on the display unit 34 (step S293).

The user uses the input unit 33 to input identification information for identifying a pattern, second identification information for identifying a second pattern, and auxiliary identification information for identifying an auxiliary pattern. The user clicks the determination button 341 when all information is inputted.

The CPU 31 receives the inputted identification information, the second identification information, and the auxiliary identification information from the input unit 33 (step S294). The CPU 31 determines whether the received identification information and the second identification information match (step S295). Specifically, the CPU 31 determines whether the pattern ID in the identification information and the pattern ID in the second identification information match. If the CPU 31 determines that the IDs match (YES in step S295), the CPU 31 reads an error screen stored in the storage unit 35 and displays the error screen on the display unit 34 (step S296). The CPU 31 returns the process to S293. A text such as “Select different patterns for the pattern and the second pattern.” can be displayed on the error screen.

If the CPU 31 determines that the identification information and the second identification information do not match (NO in step S295), the CPU 31 outputs the identification information, second identification information, and auxiliary identification information to the reader/writer 1 through the communication unit 36 (step S297).

The control unit 11 of the reader/writer 1 receives the identification information, the second identification information, and the auxiliary identification information through the communication unit 14 (step S298). The control unit 11 stores the identification information, the second identification information, and the auxiliary identification information in the memory 12 (step S299). The control unit 11 transmits a control signal including a rewriting order, the identification information, the second identification information, and the auxiliary identification information to the wireless tag 2 through the transmitting unit 18 (step S301).

The rewriting order is an order for causing the control unit 21 to rewrite the identification information, the second identification information, and the auxiliary identification information stored in the pattern storage unit 251 and the auxiliary pattern storage unit 72 of the wireless tag 2. The control unit 21 of the wireless tag 2 receives the rewriting order, the identification information, the second identification information, and the auxiliary identification information through the receiving unit 26 (step S302). In the description, the communication is already established between the wireless tag 2 and the reader/writer 1, and electric power from the power source unit 24 is supplied to the control unit 21, etc.

The control unit 21 stores the received identification information and the second identification information in the pattern storage unit 251 in compliance with the rewriting order (step S303). Specifically, the control unit 21 sets a flag to the identification information field in accordance with the pattern ID included in the identification information. Similarly, the control unit 21 sets a flag to the second identification information field in accordance with the pattern ID included in the second identification information. The control unit 21 stores the received auxiliary identification information in the auxiliary pattern storage unit 72 in compliance with the rewriting order (step S304). Specifically, the control unit 21 sets a flag to the auxiliary identification information field in accordance with the auxiliary pattern ID included in the auxiliary identification information.

The control unit 253 of the sensor 25 or a control unit not shown of the light sensor 71 may execute the processes of steps S303 and S304. If another flag is already set, the control unit 21 deletes the flag before executing the rewriting process. The control unit 21 of the wireless tag 2 transmits a response signal to the reader/writer 1, the response signal including rewriting completion information indicating that the rewriting is finished (step S305). The control unit 11 of the reader/writer 1 receives the response signal including the rewriting completion information (step S306). The control unit 11 outputs the rewriting completion information to the computer 3 (step S307).

If the rewriting completion information is received, the CPU 31 of the computer 3 displays the rewriting completion information on the display unit 34 (step S308). The CPU 31 may read a text such as “Rewriting of identification information, second identification information, and auxiliary identification information to the wireless tag 2 is finished.” from the storage unit 35 and display the text as the rewriting completion information. The CPU 31 stores the received identification information, the second identification information, and the auxiliary identification information in the storage unit 35 (step S309). In this way, an optimal pattern, etc., can be specified in accordance with the use space, etc., of the user who uses the present control system.

For example, if there is a broad inspection space or if high accuracy is required, a pattern with many variation elements can be selected. Therefore, a universal wireless tag 2 can also be provided according to the user's intention.

The configuration of the present sixth embodiment is as described above, and other parts are the same as in the first to fifth embodiments. Corresponding parts are designated with the same reference numerals and the detailed descriptions will not be repeated.

### Seventh Embodiment

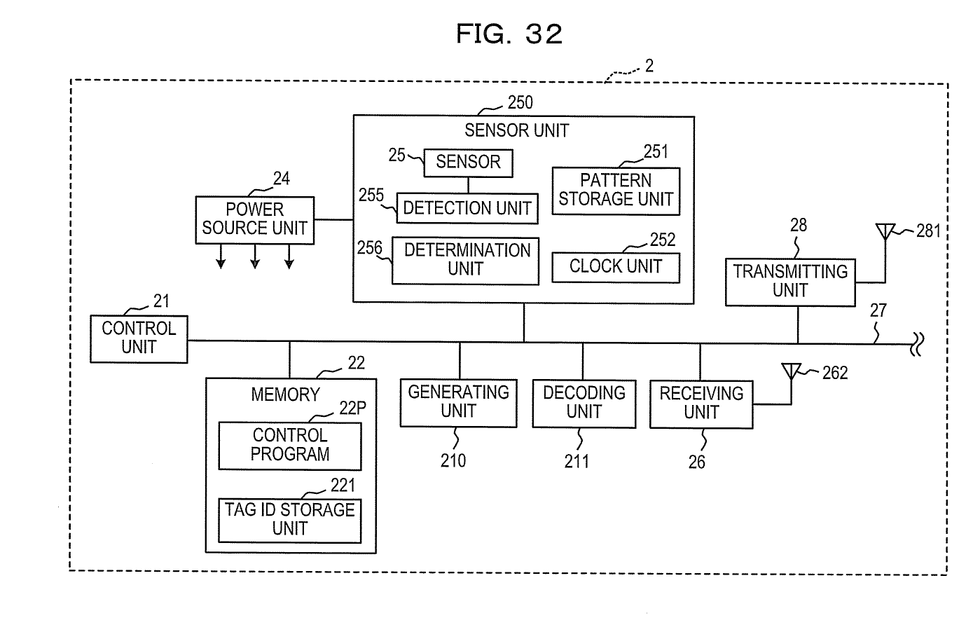

FIG. 32 is a block diagram of hardware of the wireless tag 2 according to a seventh embodiment. A sensor unit 250 includes the sensor 25, a detection unit 255, a determination unit 256, the pattern storage unit 251, the clock unit 252, etc. The sensor outputs a signal of a detected vibration, light, or sound to the detection unit 255. The detection unit 255 detects an outputted signal. The detection unit 255 outputs the detected signal to the determination unit 256. The determination unit 256 refers to time information outputted from the clock unit 252 and determines whether a signal detected in a given time range matches a pattern stored in the pattern storage unit 251. If the determination unit 256 determines that the signal and the pattern match, the determination unit 256 outputs an activation signal to the power source unit 24.

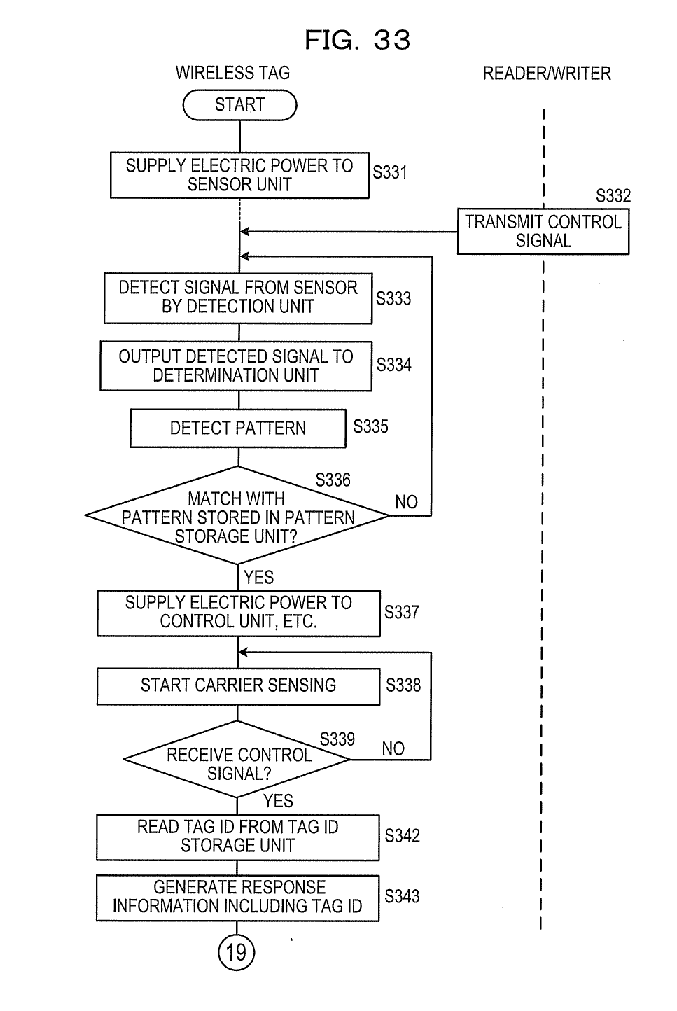

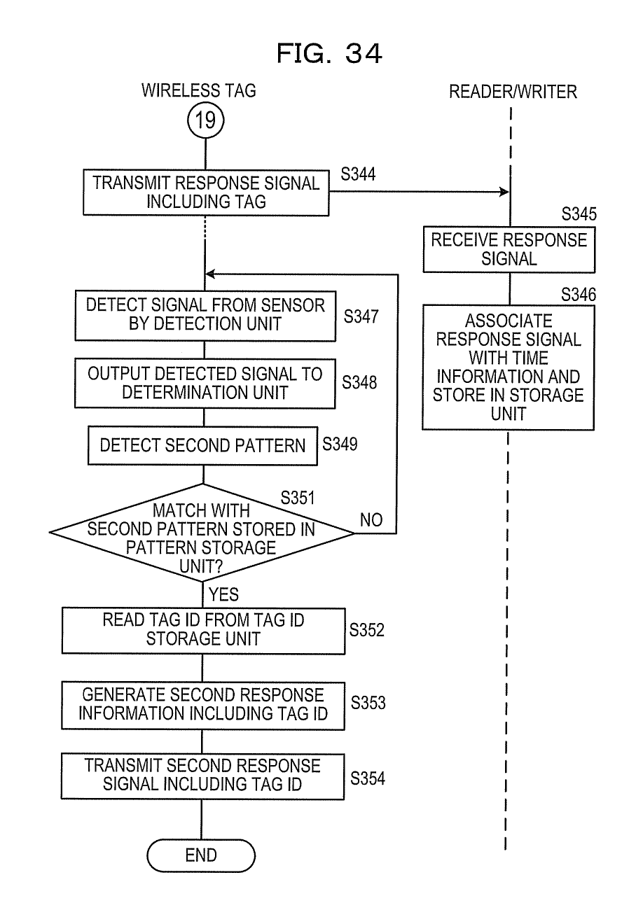

FIGS. 33 and 34 illustrate a flow chart of a procedure of a transmission and reception process. The power source unit 24 supplies electric power to the sensor unit 250 of the wireless tag 2 transferred by the conveyor belt 56 (step S331). The power of the reader/writer 1 is turned on when an activation signal from the computer 3 is received. The control unit 11 of the reader/writer 1 then outputs control information to the transmitting unit 18.

The transmitting unit 18 continuously transmits a control signal after modulation through the transmission antenna 181 (step S332). The detection unit 255 is connected to the sensor 25 and detects a signal outputted from the sensor 25 (step S333). The detection unit 255 outputs the detected signal to the determination unit 256 (step S334). The determination unit 256 performs pattern detection (step S335).

The determination unit 256 of the wireless tag 2 determines whether a pattern outputted within a given time matches one of the plurality of patterns stored in the pattern storage unit 251 (step S336). If the determination unit 256 determines that the patterns do not match (NO in step S336), the process returns to step S333, and the process is repeated.

On the other hand, the determination unit 256 outputs an activation signal to the power source unit 24 if the determination unit 256 determines that the patterns match (YES in step S336). Triggered by the reception of the activation signal, the power source unit 24 starts to supply electric power to the control unit 21, the memory 22, the generating unit 210, the decoding unit 211, the receiving unit 26, and the transmitting unit 28 (step S337). The control unit 21 starts carrier sensing by the receiving unit 26 (step S338).

The receiving unit 26 determines whether a control signal is received (step S339). If the receiving unit 26 has not received the control signal (NO in step S339), the process returns to step S338. The receiving unit 26 reads a tag ID from the tag ID storage unit 221 (step S342) if the receiving unit 26 determines that the control signal is received (YES in step S339).

The control unit 21 causes the generating unit 210 to generate response information including the tag ID (step S343). The control unit 21 transmits a response signal including the tag ID to the reader/writer 1 through the transmitting unit 28 (step S344). The receiving unit 16 of the reader/writer 1 receives the response signal (step S345). The receiving unit 16 outputs the response information after demodulation to the control unit 11. The control unit 11 associates the tag ID in the response information with time information outputted from the clock unit 13 and stores the tag ID and the time information in the memory 12 (step S346).

After step S342, a termination signal may be outputted to the power source unit 29 after a certain time (for example, five seconds), and the transmission and reception of information to and from the reader/writer 1 may be terminated. The detection unit 255 detects a signal outputted from the sensor 25 (step S347). The detection unit 255 outputs the detected signal to the determination unit 256 (step S348). The determination unit 256 performs second pattern detection (step S349). The determination unit 256 of the wireless tag 2 determines whether a pattern outputted within a given time matches the second pattern among the plurality of patterns stored in the pattern storage unit 251 (step S351).

The second pattern is different from the pattern determined in step S336. If the determination unit 256 determines that the patterns do not match (NO in step S351), the process returns to step S347, and the process is repeated.

On the other hand, if the determination unit 256 determines that the patterns match (YES in step S351), the determination unit 256 reads a tag ID from the tag ID storage unit 221 (step S352). The control unit 21 further generates second response information including the tag ID (step S353). The second response information additionally includes information indicating that the second pattern is detected. The control unit 21 transmits a generated second response signal including the tag ID to the reader/writer 1 (step S354). The subsequent process is the same as step S148, and the detailed description will not be repeated.

The configuration of the present seventh embodiment is as described above, and other parts are the same as in the first to sixth embodiments. Corresponding parts are designated with the same reference numerals and the detailed descriptions will not be repeated.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A wireless tag control method for controlling a wireless tag that communicates with a reader/writer, the wireless tag control method comprising:
passing the wireless tag through a generating unit that is placed near the reader/writer and that generates a pattern; and
starting communication between the reader/writer and the wireless when a sensor in the wireless tag detects the pattern and determines that the detected pattern matches a pattern previously stored in a storage unit of the wireless tag.

2. The wireless tag control method according to claim 1, wherein the wireless tag ends communication with the reader/writer a predetermined time after determining that the detected pattern matches the pattern previously stored in the storage unit of the wireless tag.

3. The wireless tag control method according to claim 1, wherein
the wireless tag is passed through a second generating unit that is placed near the reader/writer and that generates a second pattern different from the pattern generated by the generating unit after the wireless tag starts communication with the reader/writer, and
the communication between the wireless tag and the reader/writer ends when the wireless tag detects the second pattern and determines that the second pattern matches a second pattern previously stored in the storage unit.

4. The wireless tag control method according to claim 3, wherein
a first response signal is transmitted to the reader/writer when the wireless tag determines that the detected pattern matches the pattern previously stored in the storage unit of the wireless tag and starts communication with the reader/writer,
a second response signal is transmitted to the reader/writer when the wireless tag determines that the second pattern matches the second pattern previously stored in the storage unit, and
the reader/writer stores information indicating that the wireless tag has passed when both the first response signal and the second response signal are received.

5. The wireless tag control method according to claim 1, wherein
the reader/writer receives identification information identifying one pattern from a plurality of patterns and transmits the received identification information to the wireless tag, and
the wireless tag starts communication with the reader/writer when the sensor detects a pattern among the plurality of patterns stored in the storage unit and the pattern matches the one pattern corresponding to the transmitted identification information.

6. A wireless tag operable to communicate with a reader/writer, the wireless tag comprising:
a sensor that measures a physical quantity and converts the measured physical quantity into an electrical signal and determines whether a pattern formed by the electrical signal corresponds to a first pattern stored in advance in a storage unit; and
a communication unit that starts communication with the reader/writer when the sensor determines that the pattern formed by the electrical signal corresponds to the first pattern.

7. The wireless tag according to claim 6, further comprising:
a terminating unit that terminates communication with the reader/writer after a predetermined time has passed since the communication unit began to communicate with the reader/writer.

8. The wireless tag according to claim 6, wherein
the sensor measures, after the communication with the reader/writer begins, a second physical quantity and converts the measured second physical quantity into a second electrical signal and determines whether a pattern formed by the second electrical signal corresponds to a second pattern stored in advance in the storage unit, and
the wireless tag further includes a terminating unit that terminates the communication with the reader/writer started by the communication unit when the sensor determines that the pattern formed by the second electrical signal corresponds to the stored second pattern.

9. The wireless tag according to claim 6, further comprising:
a first transmitting unit that transmits a response signal to the reader/writer when the communication unit starts communication; and
a second transmitting unit that transmits a second response signal to the reader/writer before the communication with the reader/writer ends.

10. The wireless tag according to claim 6, further comprising:
a receiving unit that receives identification information identifying one pattern from a plurality of patterns stored in the storage unit, wherein
the communication unit starts communication with the reader/writer when the sensor determines that the pattern formed by the electrical signal corresponds to the one pattern among the plurality of patterns stored in the storage unit, the one pattern corresponding to the identification information received by the receiving unit.

11. A wireless tag operable to communicate with a reader/writer, the wireless tag comprising:
a sensor that measures a first physical quantity and converts the measured first physical quantity into a first electrical signal and determines whether a pattern formed by the first electrical signal corresponds to a first pattern stored in advance in a storage unit;
an auxiliary sensor that measures an auxiliary physical quantity different from the first physical quantity and converts the measured auxiliary physical quantity into a second electrical signal and determines whether an auxiliary pattern formed by the second electrical signal corresponds to an auxiliary pattern stored in advance in a storage unit is detected; and
a communication unit that starts communication with the reader/writer when the sensor determines that the pattern formed by the first electrical signal corresponds to the stored first pattern and the auxiliary sensor determines that the auxiliary pattern formed by the second electrical signal corresponds to the stored auxiliary pattern.

12. The wireless tag according to claim 11, further comprising:
a determining unit that determines whether an interval between a time that the sensor has detected the pattern formed by the first electrical signal and the time that the auxiliary sensor has detected the auxiliary pattern formed by the second electrical signal is within a given time stored in the storage unit, wherein
the communicating unit starts communication with the reader/writer when the determining unit determines that the interval is within the given time.
